(19) United States
(12) Patent Application Publication
(10) Pub. No.: US 2022/0379593 A1
(43) Pub. Date: Dec. 1, 2022

(54) COMPOSITE PANELS AND PARTS

(71) Applicant: Arrival Limited, London (GB)

(72) Inventors: Rob Thompson, London (GB); Denis Sverdlov, London (GB); Jennifer Chapman, London (GB); Joe Allum, London (GB)

(21) Appl. No.: 17/770,767

(22) PCT Filed: Oct. 22, 2020
(86) PCT No.: PCT/GB2020/052653

§ 371 Date: Apr. 21, 2022

(30) Foreign Application Priority Data
Oct. 24, 2019 (EP) 19205144.9
Oct. 24, 2019 (EP) 19205145.6
Oct. 24, 2019 (EP) 19205146.4
Oct. 24, 2019 (EP) 19205196.9

(51) Int. Cl. B32B 37/10; B32B 5/02; B32B 5/10; B32B 27/08; B32B 27/16; B32B 27/20; B32B 37/06; B29C 70/34

(52) U.S. Cl. CPC B32B 37/1018; B32B 5/024; B32B 5/10; B32B 27/08; B32B 27/16; B32B 27/20; B32B 37/06; B29C 70/345; B32B 2272/00; B32B 2250/02; B32B 2250/24; B32B 2250/44; B32B 2307/732; B32B 2307/4023; B32B 2307/738; B32B 2605/00; B32B 2262/148; B32B 2305/188; B32B 2305/30; B32B 2305/08; B29L 2007/002

(57) ABSTRACT

The disclosed composite structure provides a reinforced thermoplastic polymer composite part with a high-quality surface finish. This may be used as a vehicle part or body panel, such as an interior vehicle part or exterior body panel. Additionally, the surface finish may be coloured, such that the surface does not need to be painted or wrapped to achieve a desired surface colour, and the surface may protect inner layers from UV radiation, either by virtue of the material of the surface itself, or the incorporation of a UV-absorbing additive. Specifically, the disclosed composite structure comprises a structural layer comprising reinforcing fibres, such as glass or carbon fibres, and a thermoplastic body polymer. The structure further comprises a surface layer providing a surface finish to the composite structure, the surface layer comprising a thermoplastic surface polymer substantially free from reinforcing fibres.

### TECHNICAL FIELD

The present disclosure relates to parts formed of composite materials, and methods of manufacturing such a part. In particular, the present disclosure relates to a composite part that is suitable for installation in a vehicle, and a vehicle including such a composite part. Thus, the present disclosure relates to composite parts suitable for use in the automotive sector, such as an exterior panel of bodywork and an interior panel of liner.

### BACKGROUND

In the automotive sector, it is typical for the interior and the exterior of the vehicle to be formed of panels, which are supported by a frame of the vehicle.

Stamping of metal is the most routine technique for creating an exterior panel of a vehicle. It is very cost effective to stamp metal panels using a stamp tool. Stamp tooling is expensive, and so there is a motivation to reduce tooling costs. For example, a single stamp tool made from steel can typically cost on the order of US$100,000 to produce, which doesn't include the cost of a press device into which the stamp tool is to be installed.

After the stamp tool has been created, subsequent manufacture of each stamped panel is low in cost, because production is fast and automated. Accordingly, metal stamping is routinely used in the automotive sector for the mass production of components. It is prohibitively expensive to repeatedly tool up, and so as few stamp tools as possible are designed and created. For sales margins to be profitable, economies of scale are required in order to produce a single vehicle type, which involves huge capital investment and vast factories (>1M square metres).

An alternative technique to the stamping of metal is the use of a mould to create vehicle panels. A mould is used to give shape to a composite material. Composite materials are formed of a fibre and a matrix. The fibre provides strength to the panel. The matrix is used to hold the fibre in a selected shape. A carbon fibre mould can typically cost on the order of US$5,000/m², which by comparison is a factor of 20 lower than the typical cost of a stamp tool.

There is a demand for composite components that are low in cost. If tooling costs are reduced, a consequence is that it is cost effective to producing fewer components using the tools. Accordingly, this facilitates the production of vehicles in relatively low volumes (e.g. 10,000 units a year), which offers a further cost saving by reducing the amount of space used by the factory.

The techniques developed in the development of composite materials are applicable to a broad range of automotive parts, with external panels and internal panels serving as examples. Consequently, the sharing of processes for creating so many vehicle parts presents further opportunities to reduce manufacture and assembly costs.

The provision of customised components permits the manufacture of bespoke vehicles. Thus, vehicle designers are well-placed to react quickly to changing market conditions, to address environmental and urban transport challenges. To achieve this, there is a demand for a production technique that doesn't require economies of scale to be cost effective. Savings are achieved by developing manufacture techniques that are automated or semi-automated, as well as from the selection of materials that are used to create tooling and components.

The innovation described herein is not restricted to the automotive sector, and also relates to other sectors which make use of components formed of composite materials.

Reference is made to the following patent applications:
EP 19205144.9 (Section A)
EP 19205196.9 (Section B)
EP 19205146.4 (Section C)
EP 19205145.6 (Section D)
   the contents of which are incorporated by reference.

### SUMMARY

Aspects of the present invention are set out by the independent claims.

The presently disclosed subject matter is implemented by the Arrival® system. Before addressing specific features, we give a high level overview of the Arrival system for context. The Arrival system is a system for designing and manufacturing a range of vehicles, such as cars, shuttles, trucks, vans and buses, using a shared platform and shared components that are modular in both hardware and software terms. The Arrival system includes innovations in the design, organisation, manufacture, installation and operation of a broad range of vehicle components, including vehicle panels that are described in detail in this specification. The Arrival system also includes innovations that enable autonomous robotic manufacturing, including robotic manufacturing of not only vehicle panels and other components, but also complete vehicles.

The specific description provided a general introduction to the Arrival system, with details being set out in Sections A-D:
Section A of the present disclosure relates to a method of manufacturing composite parts, and an apparatus for performing the method.
Section B of the present disclosure relates to a composite part, for example a vehicle part or body panel formed from a composite structure, a corresponding composite structure and a method for manufacturing a part comprising a composite structure.
Section C of the present disclosure relates to a method for manufacturing conductive composite parts using a composite layer, the composite layer and the resulting conductive composite parts.
Section D of the present disclosure relates to a method for recycling a thermoplastic composite fabric, and the resulting recycled fabric.

Disclosure is provided of any feature from any Section being combined with any other feature from any Section. Any optional feature can be combined with any feature and with any other optional feature. Thus, disclosure is provided of a composite part according to the disclosure of any of the sections described herein, including the introduction provided by the detailed description. Similarly, disclosure is provided of a method for manufacturing a part according to the disclosure of any of the sections described herein, including the introduction provided by the detailed description.

### BRIEF DESCRIPTION OF THE DRAWINGS

Embodiments will now be described, by way of example only, with reference to the accompanying drawings, in which:

FIG. 1 illustrates a flow chart for a method of manufacturing a composite part;

FIG. 2 illustrates a flow chart for a method of moulding the composite part;

### (Drawings of EP 19205144.9)

FIG. A1 illustrates a flow chart for a method of manufacturing a composite part;

FIG. A2 illustrates part of an apparatus for manufacturing a composite part;

FIG. A3 illustrates an apparatus for manufacturing a composite part;

FIG. A4 illustrates a roll to roll apparatus for manufacturing a composite part;

### (Drawings of EP 19205196.9)

FIG. B1 illustrates a two-layer composite structure;

FIG. B2 illustrates an unconsolidated composite structure having a woven structural layer and a woven or knitted surface layer;

FIG. B3 illustrates a three-layer composite structure;

### (Drawings of EP 19205146.4)

FIG. C1 is a flow diagram of a method for preparing a conductive composite part;

FIG. C2 illustrates a consolidated conductive composite part;

FIG. C3 illustrates a consolidated conductive composite part with several layers;

### (Drawings of EP 19205145.6)

FIG. D1 is a flow diagram of a method of recycling thermoplastic composite fabric;

FIG. D2 is an illustration of offcuts of thermoplastic composite fabric being combined to form recycled thermoplastic composite fabric;

FIG. D3 is a flow diagram of an alternative method of combining offcuts to form recycled thermoplastic fabric;

FIG. D4 is an illustration of fluffed up fibres as an intermediate product of the alternative method;

FIG. D5 is an illustration of a machine for forming a non-woven fabric resulting from the alternative method; and

FIG. D6 is an illustration of a composite precursor material comprising the recycled non-woven fabric.

### DETAILED DESCRIPTION

Various embodiments, features, and aspects of the invention will be described in detail below with reference to the drawings. Each of the embodiments of the present invention described below can be implemented solely or as a combination of a plurality of the embodiments or features thereof where necessary or where the combination of elements or features from individual embodiments in a single embodiment is beneficial.

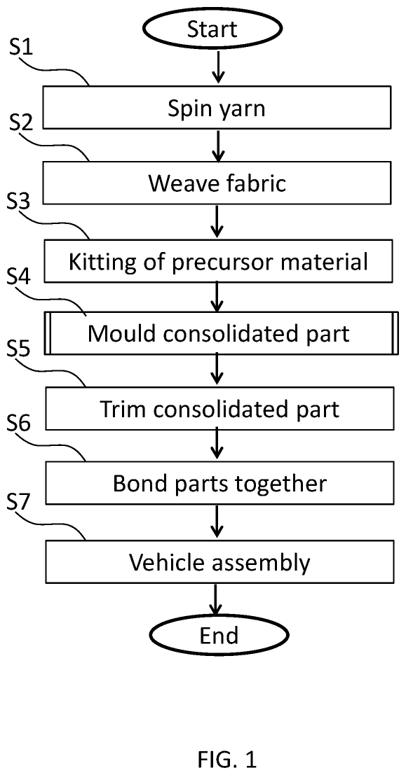

FIG. 1 illustrates a production line that is used to produce composite parts. The production line prepares a yarn (step S1), forms a bespoke fabric of precursor material (step S2), performs kitting of the fabric to produce a stack of precursor material (step S3), moulds the precursor material into shape to form the consolidated part (step S4), cuts the consolidated part into shape (step S5), bonds different parts to one another to form a part (step S6), and assembles the part into a vehicle (step S7). To the greatest extent possible, the above steps are performed autonomously by robots. These individual steps are described in detail below.

In step S1, a yarn is prepared on a spinning machine by spinning together onto a bobbin a fibre together with a matrix. As an alternative, a yarn of fibre is prepared, and a separate yarn of matrix are prepared, which are combined together when forming the fabric.

In step S2, a loom forms a bespoke fabric of precursor material, which is subsequently wound onto a roll.

In step S3, a kitting cell performs kitting of the fabric, to produce a stack of precursor material (composite structure). Offcuts of precursor material are recycled, as described in Section D.

In step S4, the precursor material is moulded into shape by a moulding cell to form the consolidated part (Section B and Section C provide examples of parts that can be produced using the techniques described herein). Consolidation of the part is independent of the orientation of the mould and the precursor material relative to one another. Examples include:
the mould being positioned below the precursor material, with the precursor material being loaded into the mould from above, wherein the precursor material is subject to a pressure differential and heating during the moulding process.
the mould being positioned above the precursor material, with the precursor material being loaded into the mould from below, wherein the precursor material is subject to a pressure differential and heating during the moulding process (see Section A).
instead, or in addition, the precursor material is subject to a pressure differential that is applied using a pressing tool.

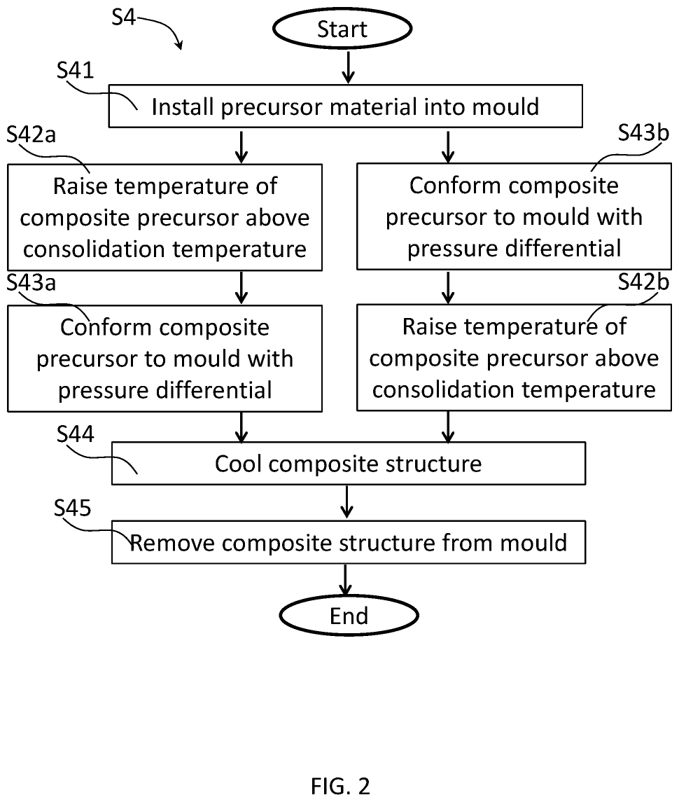

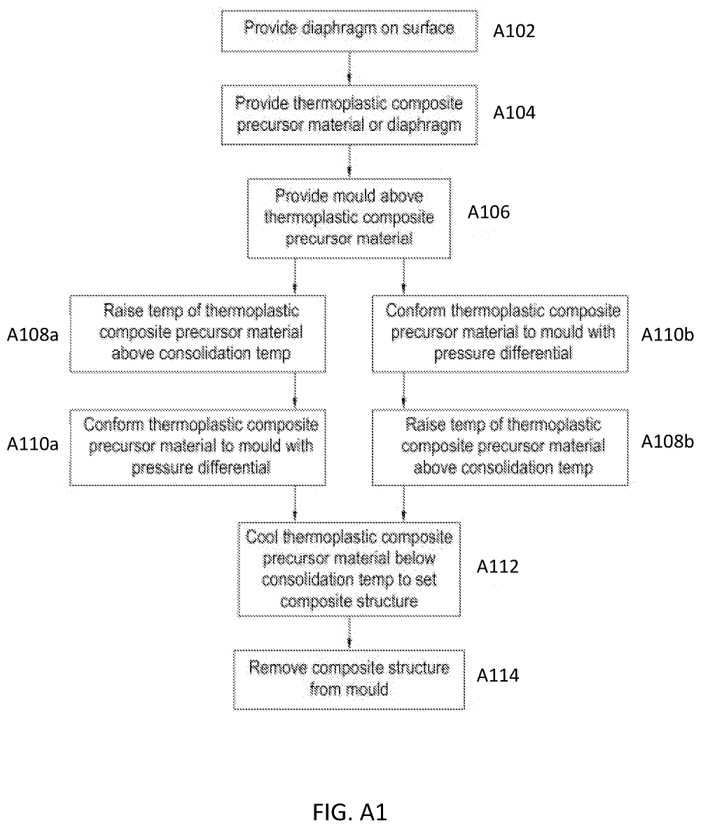

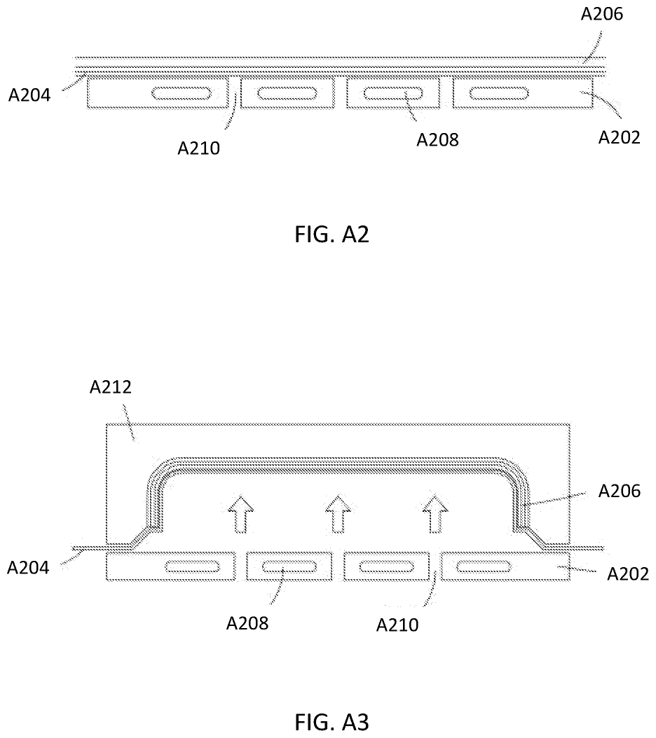

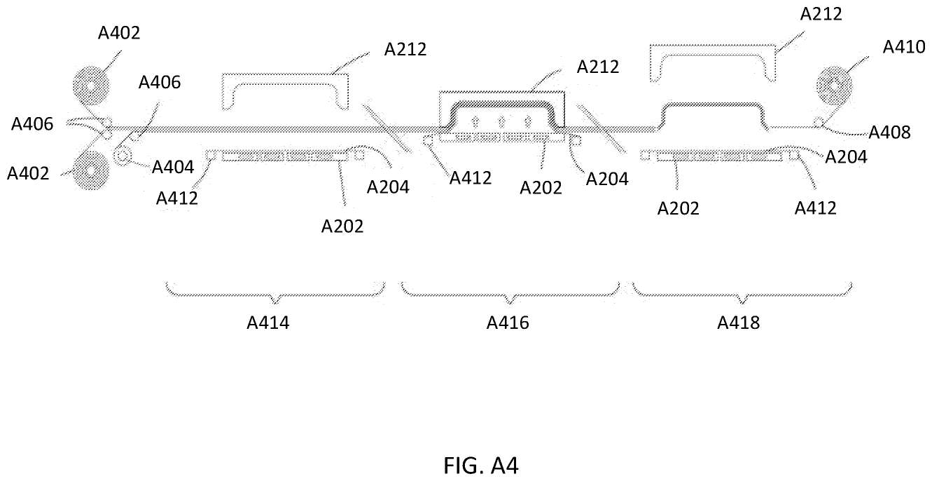

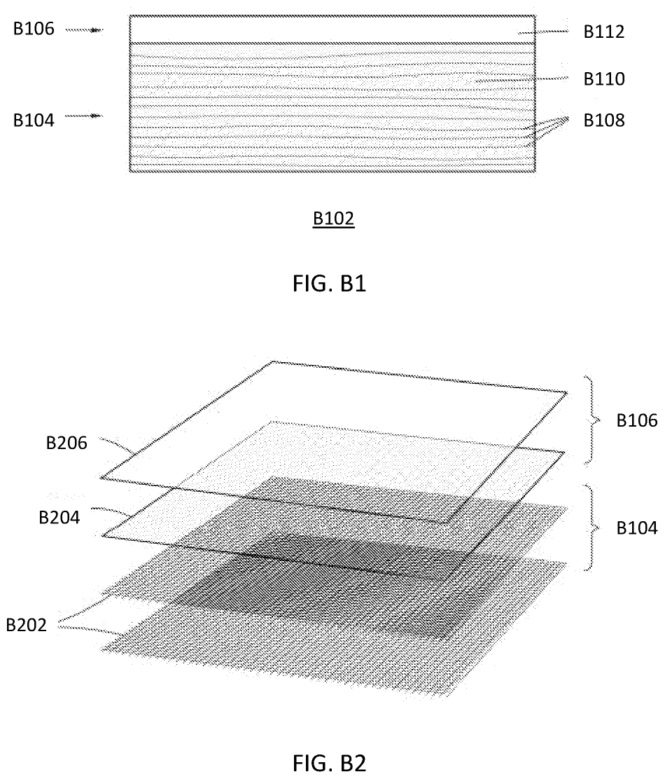

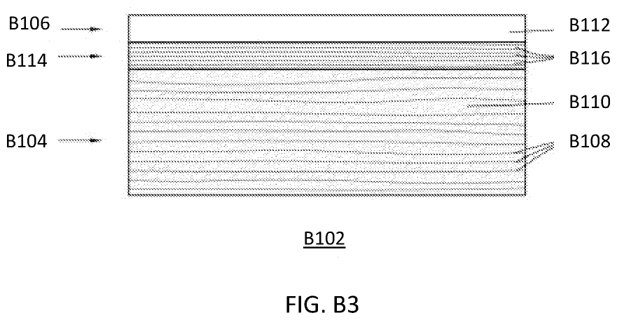

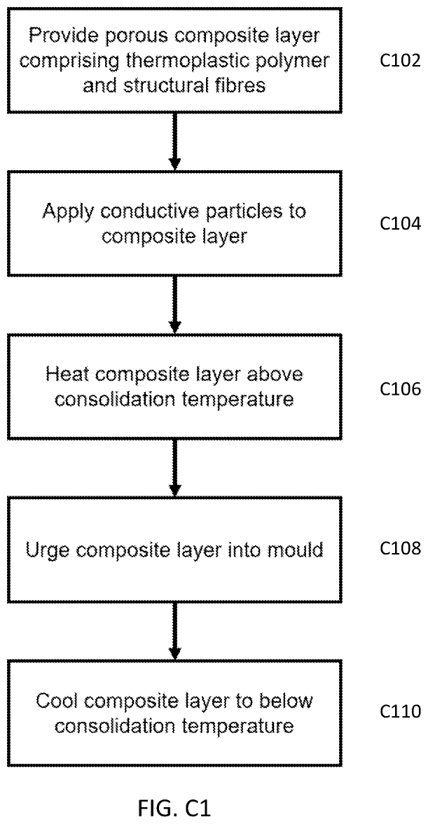

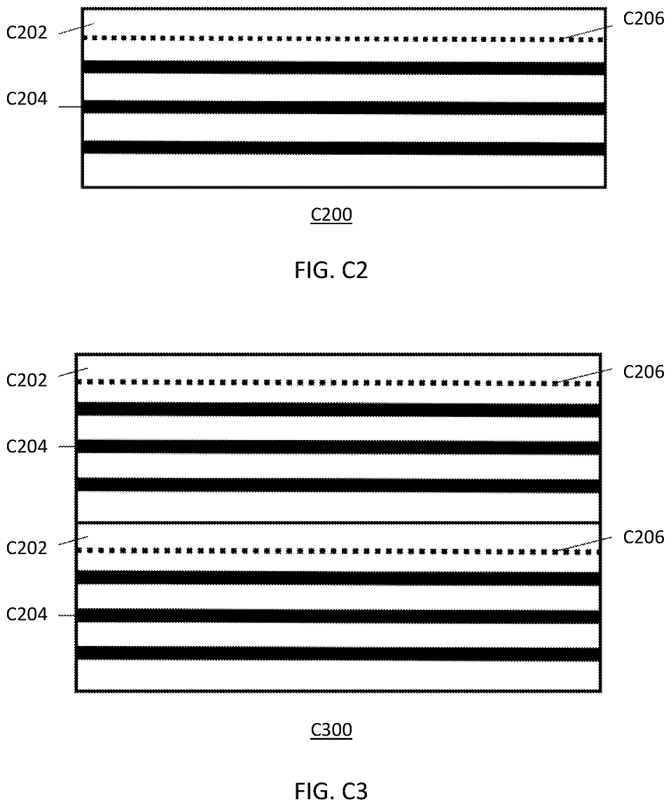

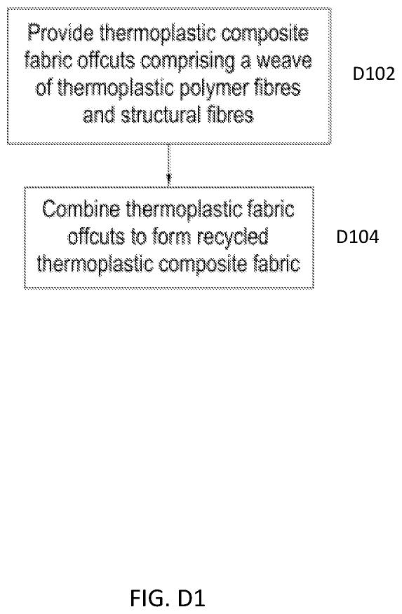

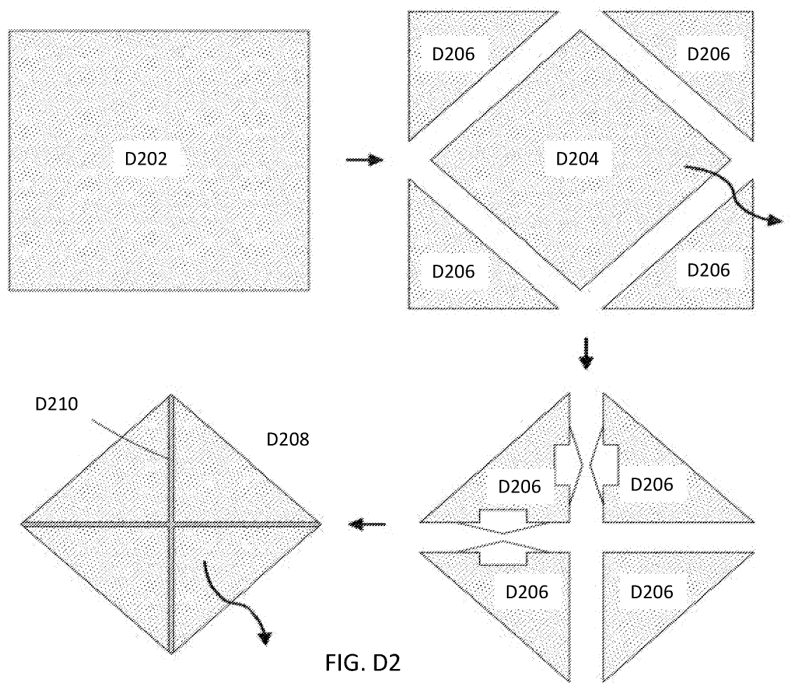

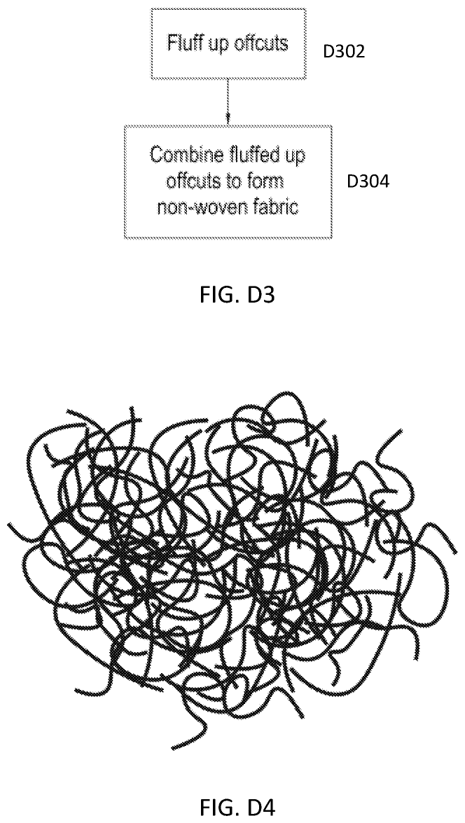

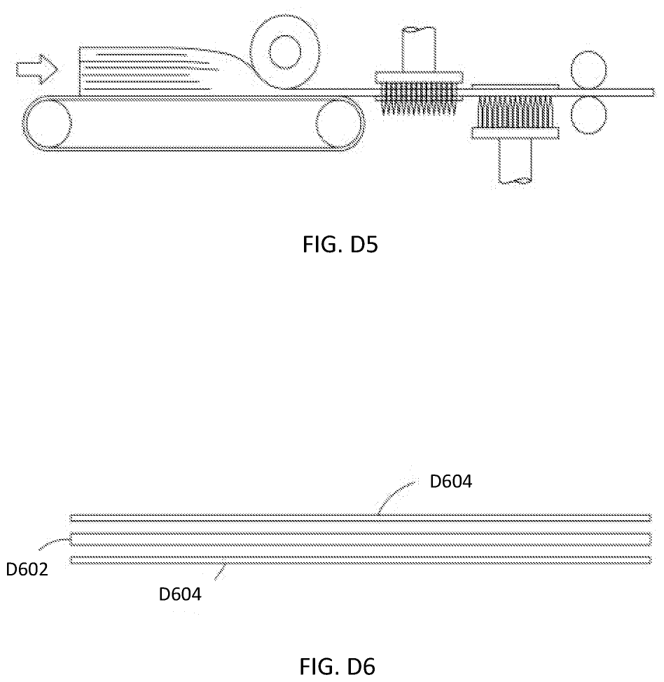

FIG. 2 provides further details of how the precursor material is moulded into shape to form the consolidated part (step S4).

In step S41, the stack of precursor material is installed into the mould. The precursor material is moved relative to the mould to bring them into contact with one another. This is achieved by placing the mould onto the mould surface, a process that is performed autonomously, or alternatively by hand.

In step S42, heat is applied, to raise the temperature of the composite precursor material above the consolidation temperature. Heat is introduced by induction, which causes the conductive mould to rapidly heat up. This melts the matrix of thermoplastic composite. Coupled with the pressure differential, this causes the matrix to flow around the reinforcement fibres.

In step S43, a pressure differential is applied to conform the composite precursor material to the mould. A membrane formed of rubber or silicone is placed over the precursor material and a vacuum is applied to evacuate the air. A valve in the mould allows the sealed cavity to remain at atmospheric pressure and so avoids distortion of the mould as a result of the heat and pressure during the moulding cycle.

It is possible for:
the heat and pressure to be applied at the same time (S42, S43);
the heat to be applied (S42a) before the pressure is applied (S43a); or
the pressure to be applied (S43b) before the heat is applied (S42b).

In step S44, the composite structure is cooled. When the induction field is removed the mould rapidly cools down. Combined with air flow introduced from above by fans, this causes the thermoplastic composite to cool and thus solidify.

In step S45, the composite structure is removed from the mould. The membrane is removed and the part is demoulded. A load sensor is used to measure the amount of force that is used to separate the consolidated part from mould. As release agent degrades, more force used to release the consolidated part. If this force exceeds a threshold, a new coat of release agent is applied to the mould.

In step S5, the consolidated part is cut into shape by a trimming cell.

In step S6, a number of sub-parts are bonded to one another by a bonding cell, to form a part that is ready for assembly into the vehicle. Bonding step S6 includes the bonding together of composite parts that have been manufactured according to steps S1-S5.

In step S7, a vehicle is assembled that includes parts manufactured according to steps S1-S6. The part (e.g. panel) is manufactured using the mould, and then assembled to form part of a vehicle. This makes it cost effective to create bespoke panels, allowing the creation of bespoke interiors and exteriors.

Section A describes an example of a production method. Section B describes an example composite structure that comprises a structural layer and a surface layer. Section C describes an example composite part with a composite layer that comprises conductive particles. Section D describes recycling of thermoplastic composite fabric.

### Section A: Manufacture of Composite Parts

### EP 19205144.9 (Arrival Ref: #0125-EP)

This section specifies the disclosure of EP 19205144.9, for which we make consistent use of figure numbers and reference numerals.

The present disclosure relates to a method of manufacturing composite parts, and an apparatus for performing the method. The disclosed manufacturing method and apparatus provide an efficient approach to the arranging and fusing steps required to manufacture composite parts, which can be readily automated. The result is a much simpler, lower cost method of manufacturing composite parts. Specifically, a method of manufacturing a composite part comprises providing a composite precursor material (composite structure) on a supporting surface, the composite precursor material comprising structural fibres; providing a mould above the composite precursor material; creating a pressure differential across the composite precursor material to conform the composite precursor material to the mould; fusing the composite precursor material to form the composite part; and finally removing the composite part from the mould. A corresponding apparatus is also disclosed.

A composite part is made from two or more constituent materials with different physical or chemical properties that, when combined, produce a part with characteristics different from the individual components. The individual components remain separate and distinct within the finished composite, differentiating composites from mixtures. Composite parts may be preferred for many reasons, for example composite parts may offer a mechanical or cost advantage when compared to parts made from mono-materials.

Thermoplastic composites are composites comprising a heat-processable thermoplastic polymer or a thermoplastic polymer polymerised in situ. Composite parts formed from thermoplastic composite materials, such as fabrics made from commingled glass and thermoplastic polymer fibres, may be preferred to thermoset composites since they tend to be tougher and recyclable; and certain types exhibit excellent resistance to chemicals and weathering (with increased molecular weight and crystallinity, thermoplastics become stiffer, stronger and more resistant to heat and chemicals).

A known technique for forming thermoset and thermoplastic composite parts uses vacuum bag moulding (also known as vacuum bagging). Layers of structural materials are first arranged in a vacuum bag. Air is sucked out of the bag to secure the layers in position relative to each other and the layers are fused, for example by melting a thermoplastic component or curing a resin incorporating the structural materials. However, the process of preparing a vacuum bag is usually time consuming and done manually. Further, it can be difficult to accurately align the thermoplastic composite materials inside the vacuum bag. This makes vacuum bag moulding good for prototyping but less suited to mass production.

An alternative known technique is to form composite parts using a mould tool that applies mechanical pressure to form the part. However, such mechanical tools are capital intensive and require significant lead times to set up the production of a given part, making changes in production expensive and time consuming. As such, this method is unsuitable for gradual ramp up of production.

Therefore, a method of manufacturing composite parts that is both fast and inherently flexible is required.

Aspects of the disclosure are set out in the independent clauses and optional features are set out in the clauses dependent thereto.

The disclosed manufacturing method and apparatus provide an efficient approach to the arranging and fusing steps required to manufacture composite parts, which can be readily automated. The result is a much simpler, lower cost method of manufacturing composite parts.

In some aspects, a method of manufacturing a composite part comprises providing a composite precursor material (composite structure) on a supporting surface, the composite precursor material comprising structural fibres; providing a mould above the composite precursor material; creating a pressure differential across the composite precursor material to conform the composite precursor material to the mould; fusing the composite precursor material to form the composite part; and finally removing the composite part from the mould.

The disclosed method provides a way of manufacturing composite parts without the need for vacuum bagging or draping of precursor materials into a mould. This is achieved by using a supporting surface to lay out and arrange the precursor materials, which is much simpler than arranging precursor materials in a vacuum bag or precisely draping materials in three dimensions. Since the supporting surface is below the precursor material, the mould being above, the precursor material is supported on the supporting surface with the help of gravity, providing a simplified arrangement for holding the precursor material in place prior to urging the precursor material into the mould. Where arranging the precursor materials is the rate determining step in the manufacture of thermoplastic composite parts, the current method may provide a significant time saving.

Additional time savings may be realised if the precursor materials are cut to shape on the supporting surface in situ or are precursor material is not pre-cut to shape but the formed part is cut-out after forming on the supporting surface. Further efficiencies can be achieved by providing the pre-cursor material in an automated fashion from a roll of fabric or on conveyor belt, both of which are enabled by virtue of the materials being first laid out on a flat surface. Furthermore, since the precursor materials can be heated while still laid out (before being pressed into a mould), the present method does not require expensive heated or double-sided moulds, which are capital intensive and require significant lead times to tool up for the production of a given part.

It will be appreciated that fusing the composite precursor material may comprise, for example, consolidating, fully or partially melting or sintering the composite precursor material, and/or may comprise activating a chemical reaction, such as a polymerisation reaction. The composite precursor material may comprise two or more sub-layers, for example sub-layers formed from a mesh of structural fibres, alternating layers of polymer and fibres, multiple layers of woven or non-woven composite fabric. One or more cores, for example honeycomb or foam cores as described further below, may be disposed may be disposed between the layers. The fibres may be glass fibres, carbon fibres or any other type of fibre reinforcement. The mould may be arranged to move into place above the composite precursor material. The mould may be raised and lowered, or moved into place mechanically, robotically and/or hydraulically.

In some embodiments, fusing the composite precursor material comprises applying heat to the composite precursor material to raise the temperature of the composite precursor material above a reaction threshold temperature to fuse the precursor material; and cooling the composite precursor material to below the reaction threshold temperature to set the composite part, prior to removing the composite part from the mould. The heating can precede applying pressure and vice versa. When the composite precursor material is cooled to below the reaction threshold temperature to set the composite part, it is set in the sense that it becomes substantially solid and fixed in shape. The reaction threshold temperature can be the temperature at which a physical reaction occurs (such as melting, partial melting, consolidation or sintering), or the temperature at which a chemical reaction occurs (such as polymerisation).

The composite precursor material comprises a thermoplastic polymer. More specifically, the composite precursor material may comprise thermoplastic polymer fibres, and the thermoplastic polymer fibres may be combined, for example commingled or parallel woven, with the structural fibres to form a yarn. The combined thermoplastic polymer fibres and structural fibres may be woven together to form a fabric or may be otherwise combined to form a non-woven fabric. The composite precursor material may comprise several structural layers comprising structural fibres. The composite precursor material may in any case comprise a surface layer (which in turn may have one or more layers).

The terms “yarn” and thread are used in a broad sense to cover any yarn or thread of a suitable form factor to be woven, knitted or otherwise constructed into a fabric. In the same sense, the term “fibre” is understood to cover a wide range filaments and cross-sectional form factors of the fibre and is understood to cover tape, and in particular spread tow tape, in relation to either or both of reinforcing and thermoplastic polymer fibres. The yarn may be a combined yarn formed by combining, for example commingling or parallel weaving, different fibres, for example fibres of thermoplastic polymer and reinforcing fibres. A fabric for use in the disclosed processes may be constructed from such a yarn by weaving, knitting or in any other suitable manner.

Fusing a composite precursor material (composite structure) comprising a thermoplastic polymer to form the composite part may comprise sintering, melting or partially melting (for example melting the outside of fibres of the thermoplastic polymer) the composite precursor material. It may also comprise consolidating the thermoplastic polymer and structural fibres, for example heating them such that the thermoplastic polymer becomes fluid enough to flow around the structural fibres. In these cases, the reaction threshold temperature may be the melting point of the thermoplastic polymer or the glass transition temperature of the thermoplastic polymer. Alternatively, fusing a composite precursor material comprising a heat activated thermosetting resin (also known as thermoset) also comprises heating the thermosetting resin, wherein the composite precursor material fuses upon heating, possibly in a catalyst triggered reaction. Fusing a composite precursor material comprising an adhesive or thermosetting resin, such as an epoxy resin may comprise allowing the adhesive to set or the resin to cure, either with or without the provision of additional heat during heat processing.

The adhesive or resin may be a fast-setting adhesive or fast-curing resin, respectively.

In accordance with the above, the reaction threshold temperature is a temperature threshold at which a physical (e.g. melting) or chemical (e.g. polymerisation) reaction occurs.

In some embodiments, providing the precursor material involves paying out precursor material from a first roll and taking up waste material from a previous manufacturing step on a second roll, the first and second rolls being disposed on opposite sides of the surface. In this way, roll to roll manufacturing of composite parts is provided.

In some embodiments, the pressure differential across the composite precursor material is created by increasing the pressure underneath the composite precursor material. Alternatively, or additionally, gas may be evacuated from the mould. A pressure source used to create the pressure differential could be a pump and could be a source of negative pressure and/or positive pressure, as the case may be. In some embodiments, the composite precursor material is disposed on a diaphragm and the pressure differential is also created across the diaphragm to conform the composite precursor material to the mould.

In embodiments with a diaphragm, the supporting surface may be the diaphragm and the precursor material may be laid out on the diaphragm. The diaphragm can be supported in turn on a further supporting surface on a supporting member like a table or any other suitable supporting member or can be secured in a frame or the like, without the need for a separate further supporting surface. When there is no diaphragm, the supporting surface may be any suitable surface the precursor can be laid out on, for example a surface of a table, floor, shelf, block or similar.

In some embodiments, a fluid (liquid or gas as the case may be) tight seal may be formed between the diaphragm and the supporting surface and/or the mould. Having a tight seal facilitates the generation of a pressure differential but is not necessary to achieve this, as an amount of fluid flow leaking from between the diaphragm and any supporting surface and/or mould can be compensated by fluid flow from a reservoir.

In some embodiments, the method further comprises cutting the composite precursor material on the supporting surface to release a formed part from the pre-cursor material. Alternatively or additionally, the composite pre-cursor material may be pre-cut to shape on the supporting surface or otherwise.

In further aspects, an apparatus for manufacturing a composite part comprises a supporting surface for laying out a composite precursor material comprising structural fibres. A mould (which may comprise a surface pattern for imparting a corresponding pattern to the composite precursor material) is disposed above or moveable to being above the supporting surface for receiving the composite precursor material and one or more fluid conduits are configured to remove or supply fluid to create a pressure differential across the composite precursor material to conform the composite precursor material to the mould. Such an apparatus supports implementation of a method as described above.

In some embodiments, the apparatus comprises a diaphragm to provide the supporting surface and the fluid conduits are configured to create the pressure differential across the diaphragm.

The apparatus may comprise, in some embodiments, a heat source for heating the composite precursor material, in some specific embodiments with a supporting member for carrying or providing the supporting surface, integrated into the supporting member. Alternatively, for example when a diaphragm is provided, it may be preferable to put a heater above the table to not heat through the diaphragm. In some embodiments, the diaphragm is disposed on the supporting member and the fluid conduits pass through the supporting member.

In some embodiments, a respective set of one or more rolls are disposed on (laterally) opposed sides of the mould and supporting surface to provide the precursor composite material from one set of rolls and take up waste material (offcut material) with the other set of rolls. In this way, roll to roll processing is supported.

A cutter configured to cut the composite precursor material on the supporting surface may be provided. The cutter may be arranged to release a formed part from precursor composite material, in particular if roll to roll processing without pre-cutting occurs. Alternatively or additionally, the cutter may be used to pre-cut the composite precursor material.

### Detailed Description of EP 19205144.9

With reference to FIG. A1, a method of manufacturing a composite part from a composite material will be described. A diaphragm A204 is provided A102 on a table A202. The table A202 does not need to be a table per se and can be any supporting surface or structure for supporting the diaphragm A204, e.g. a floor, ledge, shelf or any other surface or structure.

The table A202 may be a conventional table for supporting the diaphragm A204, although optional advantageous features of the table A202 are discussed below.

Thermoplastic composite precursor material A206 is provided A104 on the diaphragm A204. This is illustrated in FIG. A2, which shows the table A202, diaphragm A204 and thermoplastic composite precursor material A206.

The thermoplastic composite precursor material A206 comprises a thermoplastic polymer, such as polypropylene or polyester. The thermoplastic composite precursor material A206 also comprises a reinforcing material, such as glass or carbon fibres.

The diaphragm A204 is made of any suitable material known to the skilled person used in conventional vacuum bagging processes, such as silicone. In embodiments in which the diaphragm is re-used, the diaphragm is made from a material capable of withstanding the temperatures used to process the composite, for example at the melting point of the polymer.

In other embodiments, the diaphragm is itself thermoplastic at the processing temperatures and becomes incorporated with the part precursor material A206 and the resulting part.

An example of a suitable thermoplastic composite precursor material A206 is a combined, for example commingled, glass and thermoplastic weave, which comprises glass fibres commingled or otherwise combined with polypropylene filaments that form a combined yarn, which is woven into a fabric. Similar fabrics are equally suitable. Further examples include unidirectional tape comprising a polypropylene or other thermoplastic polymer matrix and continuous glass or carbon fibre reinforcement.

Of course, the thermoplastic polymer and reinforcing material do not need to be commingled or use otherwise combined yarn. For example, the thermoplastic composite precursor material A206 may be formed from alternating layers of thermoplastic polymer and a reinforcing material, such as alternating layers of polypropylene sheet and reinforcing glass fibre fabric or weave.

As would be understood by the person skilled in the art, while only one thermoplastic composite precursor material A206 is required, multiple layers of the same or different thermoplastic composite precursor material may be assembled on top of each other, as required by the target composite part. For example, two layers of thermoplastic composite precursor material A206 (e.g. two layers of glass fibre/polypropylene weave) may be combined to form a thicker and stronger composite part. Core materials, such as honeycomb, foam and balsa, can be provided on, under or between layers of thermoplastic composite precursor material A206. These core materials can be used to tailor the properties of the target composite part. Core materials include other high-performance fibres, thermoplastic matrix materials and lightweight cores to be used where necessary to provide additional strength, stiffness and durability. For example, honeycomb can provide additional lightweight support, while foam can be used as a core to increase the dimensions of the target composite part without significantly increasing weight.

Thus, the thermoplastic composite precursor material A206 and any additional materials are assembled A104 on the diaphragm A204 according to the requirements of the target composite part. The materials may be cut prior to being placed onto the table A202, or they may be cut in situ, for example using an ultrasonic cutter, laser, saw, stamp-cutter (also known as a cookie-cutter) or any other conventional cutting means known to the skilled person.

The shape of the thermoplastic composite precursor material A206 and any additional layers of material are defined by pre-determined stress as determined by the shape of the target composite part (that is, fibre layout and orientation, as well as the number of layers, is determined by the expected loads and direction of the load). In other words, like the pattern of a suit, the materials are cut and laid out. Methods for determining the shape of the thermoplastic composite precursor material A206 and any additional layers of material, based on a target composite part, are well-known in the fields of vacuum bagging and plastic composite manufacture, and can be readily applied to the present method.

The thermoplastic composite precursor material A206, e.g. commingled or otherwise combined glass and thermoplastic polymer fabric, may be provided from a roll of thermoplastic composite material that is fed onto the diaphragm A204 on the table A202 by a machine, conveyer belt or robot. Accordingly, the step of providing A104 the thermoplastic composite precursor material A206 on the diaphragm A204 can be readily automated. Further, the thermoplastic composite material can be cut into shape in situ (i.e. on the diaphragm A204). This can also be performed by a robot, further automating the process. Thus, laying out the thermoplastic composite precursor material A206 is well suited to automation using well-developed robotic technologies.

With reference to FIG. A3, a mould A212 is provided above the thermoplastic composite precursor material A206. The mould A212 can be moved into position above the thermoplastic composite precursor material A206, for example using a robotic arm, or the thermoplastic composite precursor material A206 can be moved under the mould A212, the mould A212 being stationary. That the mould A212 can be moved into position above the thermoplastic composite precursor material A206 on the table A202, or alternatively, the thermoplastic composite precursor material A206 may be slid into the gap between mould A212 and table A202, for example, using a conveyor belt.

Independent of the embodiment, either the precursor material A206 slides across the diaphragm A204 or the diaphragm A204 and precursor material A206 slide into position together. Thus, the diaphragm A204 may be provided together with the precursor material A206.

The mould A212 is a single-sided tool, and more expensive double-sided tools are not required.

Conventional methods of fabricating thermoplastic composite parts comprise using the mould or tool to heat the thermoplastic material. While it is possible to heat the thermoplastic composite precursor material A206 using the mould A212 of the present method, it is typically undesirable to do so, since it is much easier to heat the thermoplastic composite precursor material A206 before it contacts the mould A212 instead. Further, heated moulds are significantly more expensive than unheated moulds.

In first embodiments, while still on the table A202, the thermoplastic composite precursor material A206 is heated A108a to raise the temperature of the thermoplastic composite precursor material A206 above a consolidation temperature.

At the consolidation temperature, the thermoplastic composite precursor material A206 becomes soft (i.e. fluid enough to flow around the structural fibres, when present). The thermoplastic polymer in the thermoplastic composite precursor material A206 may melt at the consolidation temperature, in which case, fibres of the polymer will fuse together when cooled below the melting point, forming a continuous structure.

Thus, the consolidation temperature may be equal to or above the highest of the glass transition and melting temperature of the thermoplastic polymer in the thermoplastic composite precursor material A206, although it may also be lower, so long as the thermoplastic polymer is softened (for example, such that it becomes hot enough to stick to the structural fibres or even fluid enough to infiltrate the structural fibres). The consolidation temperature is typically between 180-220° C., depending of course on the nature of the thermoplastic polymer present. For example, this temperature range is suitable for polypropylene.

The thermoplastic composite precursor material A206 may be heated using any conventional means known to the skilled person such as using an infra-red heat source or a hot-plate.

In some embodiments, heating elements A208, as illustrated in FIG. A3, are located in the table and are used to heat the thermoplastic composite precursor material A206. These may be electric or induction heating elements or channels arranged to circulate hot water or oil, or any other heating element known to the skilled person.

After heating A108a the thermoplastic composite precursor material A206 on the table A202, a pressure differential is created A110a across the diaphragm A204 such that the diaphragm A204 conforms the thermoplastic composite precursor material A206 to the mould A212 and then stretches the thermoplastic composite precursor material A206 to the shape of the mould A212.

The pressure differential may be created A110a using vacuum pressure (negative pressure) alone (for example at 1 bar) by evacuating air from inside the mould A212. In addition to or instead of creating a vacuum on the mould A212 side of the diaphragm A204, a positive pressure (for example up to 8 bar) may be introduced on the table A202 side of the mould A212. This may provide higher definition of detail in the final composite part and a shorter cycle time. Positive pressure may be provided by, for example, pressurised fluid such as pressurised gasses including pressurised air, nitrogen, or any other gas known to the skilled person, or by liquids such as water, oil or other suitable heating media.

In order to help create and maintain the pressure differential, the diaphragm A204 may form a gas tight seal against the table A202 and/or the mould A212, although this is not essential since a pressure differential can still be maintained even if there is a gap between the diaphragm A204 and table A202 or mould A212.

Preferably, fluid conduits A210, as illustrated in FIG. A3, are located in the table A202. Gas flows in/out through individual fluid conduits A210 to allow for controlled stretching of the diaphragm A204 and maximise forming efficiency.

In second embodiments, the thermoplastic composite precursor material A206 may be pressed A110b against the mould A212, as described above, before being heated A108b. Thus, the thermoplastic composite precursor material A206 is heated while in the mould A212. In this instance, instead of or in addition to the heating methods described above, the mould A212 may be used to heat the thermoplastic composite precursor material A206. For example, the mould A212 may comprise electric heating elements or channels for circulating hot water or oil.

Finally, after being heated and conformed to the mould A212, the thermoplastic composite precursor material A206 is cooled A112 to below the consolidation temperature to fuse or set the composite part.

This may be done passively, by simply removing the heat source used to heat the thermoplastic composite precursor material A206, or actively, for example using a chiller or cold air source.

The composite part can then be removed A114 from the mould A212 after releasing the pressure differential.

A new thermoplastic composite precursor material A206 can then be provided and, optionally, cut to size in situ, both in an automated fashion or otherwise, and the process repeated.

In accordance with the above, an embodiment of an apparatus for manufacturing a composite part comprises a table A202 for laying out a thermoplastic composite precursor material A206 on a surface of the table A202. A table A202 is just one embodiment of providing a supporting surface for the precursor material A206 and a supporting surface may be provided in any suitable way in various embodiments, for example on a floor, block, shelf, ledge and so forth.

A mould A212 for receiving the thermoplastic composite precursor material A206 is disposed above the table A202 on a moveable support gantry to allow the mould to be brought into contact with the thermoplastic composite precursor material A206 for forming the composite part, as described above. In some embodiments, the mould A212 is fixed instead of being moveable and disposed with a clearance above the table A202 to enable the thermoplastic composite precursor material A206 on the diaphragm A204 to be slid into position under the mould A212. In the latter case in particular, the precursor material A206 may slide across the diaphragm A204 or the diaphragm A204 and precursor material A206 may slide into position together. The diaphragm A204 may in some embodiments be part of the apparatus or may be provided separately together with the precursor material A206.

The apparatus may further comprise a heat source A208 for heating the thermoplastic composite precursor material A206. The heat source A208 may be an electric heating element or a channel arranged to circulate hot water or oil, or any other heating element known to the skilled person. The heat source A208 may be integrated into the supporting surface/table A202 or into the thermoplastic composite precursor material A206. For example, conductive fibres may be incorporated in the thermoplastic composite precursor material and used for ohmic or inductive heating.

The apparatus comprises one or more fluid conduits A210 configured to remove or supply fluid to create a pressure differential across the diaphragm A204 and thermoplastic composite precursor material A206 to conform the precursor material A206 to the mould A212. The apparatus may further comprise one or more pumps or pressure sources for creating the pressure differential across the diaphragm A204, or these may be provided separately, for example in the form of a vacuum or compressed air line. Whether the pump or pressure source is provided with the apparatus or not, the table A202 (or other supporting surface) and/or the mould A212, as the case may be, may comprise the fluid conduits A210 for supplying or removing fluid through the table A202 surface or an inner surface of the mould A212 to generate the required positive and/or negative pressure.

A robot arm comprising an ultrasonic cutter, laser, saw, stamp-cutter (also known as a cookie-cutter) or any other conventional cutting means known to the skilled person for cutting the thermoplastic composite precursor material A206 may be provided with or in addition to the apparatus.

FIG. A4 illustrates a roll to roll manufacturing apparatus and method. A set of rolls A402 stores precursor material A206, one roll for each layer of precursor material A206 if there are multiple layers. A further roll A404 stores a surface material A405 in embodiments where such a material is used. The materials from rolls A402, A404 pass through rollers A406 to rollers A408, to be taken up by a waste roll A410. In between the rollers A406, A408, the precursor material A206 and (where present) the surface material A405 pass in between a table A202 (or other surface) as described above and a mould A211 as described above and disposed above the table A202. A diaphragm A204 as described above is disposed between the surface material A405 (where present) or the precursor material A206 and is held in a frame A412. The frame A412 may accommodate the table A202 and provide a clearance around it to increase the range of possible relative motion. It will be appreciated that diaphragm A204 may be held in any other suitable way, for example secured to the table A202 or paid out between a corresponding pair of rolls.

In operation, in a first step A414, a fresh length of material (precursor material A204 and where applicable surface material A405) is paid out from the set of rolls A402 and disposed in between the mould A212 and diaphragm A204. The slack of waste material from a previous manufacturing step is taken up by waste roll A410. In a second step A416 one or both of the table A202 and mould A412 move relative to each other to hold the material and diaphragm against the table, optionally forming a seal between the diaphragm and the table. The frame A412 and table A202 may optionally also move relative to each other to dispose the diaphragm A204 tautly on the table A202. The material is heated and once sufficiently softened is urged into the mould by pressure, for example positive pressure applied through the table A202, as described above. Subsequently, the material is allowed to cool and hence solidify. In a third step A416, one or both of the mould A212 and table A202 move apart to release the part formed by the hardened material and the part is cut out and released from the remainder of the roll to roll material, at which point the apparatus is ready to repeat the process starting again at step A414. The table A202 may remain in contact with the material at this step to provide a support surface to facilitate the cutting out of the formed part and may then, optionally, move away from the fabric to provide a clearance or the table may be stationary during the whole process.

It will be appreciated that the illustration of steps A414 to A418 in FIG. A4 is schematic and that the table and mould arrangement in between does not necessarily move laterally between the rolls A406, A408. Rather, the displacement in FIG. A4 is representative of the passage of time.

In further embodiments, roll to toll or otherwise, the diaphragm A204 may not be provided. In some embodiments, the thermoplastic composite precursor material is sufficiently impermeable to the pressuring fluid such that the thermoplastic composite precursor material A206 can be urged into contact by the pressure differential in the absence of the diaphragm A204, and so the diaphragm A204 is not essential. Equally, the diaphragm may be suspended in a frame or at suspension points and stretched to provide the surface on which the pre-cursor material can be laid out, so that a separate surface (of a table or otherwise) is not required. These variations can be combined by using a sufficiently impermeable pre-cursor material suspended as described above.

In any of the described embodiments, the thermoplastic composite precursor material A206 may be substituted for a different composite precursor material, such as a composite precursor material comprising an adhesive or thermosetting resin. Since it is not essential to heat such a composite precursor material to fuse or set the composite part, the heating step described above is not essential in this instance and can be omitted. As such, a composite precursor material comprising an adhesive or thermosetting resin will fuse whilst being urged into the mould, in order to form the composite part. Of course, a heating step may still be used to accelerate the fusing of the adhesive or thermosetting resin, respectively, and the heating step may be required, for example if the thermosetting resin is a heat activated thermosetting resin.

It will be appreciated that the above description is made by way of example and not limitation of the scope of the appended clauses, including any equivalents as included within the scope of the clauses. Various modifications are possible and will be readily apparent to the skilled person in the art. Likewise, features of the described embodiments can be combined with any appropriate aspect described above and optional features of any one aspect can be combined with any other appropriate aspect. The described manufacturing method and apparatus may be used in the context of manufacturing composite parts for electric vehicles, for example. The disclosure is however not limited to this application but rather is applicable to composite parts for any purpose, vehicular or otherwise, and for any type of vehicle, be that other road vehicles, for example being driven by internal combustion engines, naval vehicles such as boats, ships and other vessels and airborne vehicles such as planes, helicopters and the like.

### Clauses Corresponding to the Claims of EP 19205144.9

A1. A method of manufacturing a composite part, the method comprising:
providing a composite precursor material on a supporting surface, the composite precursor material comprising structural fibres;
providing a mould above the composite precursor material;
creating a pressure differential across the composite precursor material to conform the composite precursor material to the mould;
fusing the composite precursor material to form the composite part; and
removing the composite part from the mould.

A2. The method of clause A1, wherein fusing the composite precursor material comprises:
applying heat to the composite precursor material to raise the temperature of the composite precursor material above a reaction threshold temperature to fuse the precursor material; and
cooling the composite precursor material to below the reaction threshold temperature to set the composite part, prior to removing the composite part from the mould.

A3. The method of clause A2, wherein the composite precursor material comprises a thermoplastic polymer.

A4. The method of clause A3, wherein the composite precursor material comprises thermoplastic polymer fibres, and the thermoplastic polymer fibres are combined with the structural fibres, and optionally wherein the combined thermoplastic polymer fibres and structural fibres are woven together to form a fabric.

A5. The method of any preceding clause, wherein providing the precursor material comprises paying out precursor material from a first roll and taking up waste material from a previous manufacturing step on a second roll, the first and second rolls being dispose on opposed sides of the mould and supporting surface.

A6. The method of any preceding clause, wherein the pressure differential across the composite precursor material is created by increasing the pressure underneath the composite precursor material.

A7. The method of any preceding clause, the method further comprising providing a diaphragm, wherein the composite precursor material is provided on the diaphragm and the pressure differential is also created across the diaphragm to conform the composite precursor material to the mould.

A8. The method of any preceding clause, the method further comprising cutting the composite precursor material on the supporting surface to release a formed part from the pre-cursor material.

A9. An apparatus for manufacturing a composite part, the apparatus comprising:
a supporting surface for laying out a composite precursor material comprising structural fibres;
a mould disposed above or moveable to being above the supporting surface for receiving the composite precursor material; and
one or more fluid conduits configured to remove or supply fluid to create a pressure differential across the composite precursor material to conform the composite precursor material to the mould.

A10. The apparatus of clause A9, further comprising a diaphragm, wherein the supporting surface is the surface of the diaphragm and the fluid conduits are configured to create the pressure differential across the diaphragm.

A11. The apparatus of clause A9 or A10, comprising a supporting member for carrying or providing the supporting surface, wherein a heat source for heating the composite precursor material is integrated into the supporting member.

A12. The apparatus of clause A10, wherein the diaphragm is disposed on a supporting member and the fluid conduits pass through the supporting member, optionally wherein a heat source for heating the composite precursor material is integrated into the supporting member.

A13. The apparatus of any one of clauses A9 to A12, wherein respective sets of one or more rolls are disposed on opposed sides of the mould and supporting surface to provide the precursor composite material from one set of rolls and take up waste material with the other set of rolls.

A14. The apparatus of any of clauses A9 to A13, further comprising a cutter configured to cut the composite precursor material on the supporting surface to release a formed part from the precursor composite material

A15. The apparatus of any of clauses A9 to A14, wherein the apparatus is arranged to perform the method of any of clauses A1 to A8.

### Section B: Composite Panels and Parts

### EP 19205196.9 (Arrival Ref: #0126-EP)

This section specifies the disclosure of EP 19205196.9, for which we make consistent use of figure numbers and reference numerals.

The present disclosure relates to a composite part, for example a vehicle part or body panel formed from a composite structure, a corresponding composite structure and a method for manufacturing a part comprising a composite structure. The disclosed composite structure provides a reinforced thermoplastic polymer composite part with a high-quality surface finish. This may be used as a vehicle part or body panel, such as an interior vehicle part or exterior body panel. Additionally, the surface finish may be coloured, such that the surface does not need to be painted or wrapped to achieve a desired surface colour, and the surface may protect inner layers from UV radiation, either by virtue of the material of the surface itself, or the incorporation of a UV-absorbing additive. Specifically, the disclosed composite structure comprises a structural layer comprising reinforcing fibres, such as glass or carbon fibres, and a thermoplastic body polymer. The structure further comprises a surface layer providing a surface finish to the composite structure, the surface layer comprising a thermoplastic surface polymer substantially free from reinforcing fibres. By providing a surface layer without the reinforcing fibres, the reinforcing fibres are shielded from the surface and print-through is consequently reduced, resulting in an improved surface finish.

Composite panels and parts formed from thermoplastic polymers comprising reinforcing fibres are desirable for their light weight, high strength and versatility. However, certain thermoplastic polymers have a dull surface finish, while the reinforcing fibres within the panels and parts exhibit ‘print-through’ as a result of the thermoplastic matrix shrinking as it cools during manufacture. This currently prohibits the use of such composites on the surface of panels and parts that must be aesthetically pleasing, i.e. have a smooth and shiny surface finish, or requires additional finishing treatments to achieve the desired finish.

Aspects are set out in the independent clauses and optional features are set out in the clauses dependent thereto.

The disclosed composite structure provides a reinforced thermoplastic polymer composite part with a high-quality surface finish. This may be used as a vehicle part or body panel, such as an interior vehicle part or exterior body panel. Additionally, the surface finish may be coloured and/or grained (textured), such that the surface does not need to be painted or wrapped to achieve a desired surface colour, and the surface may protect inner layers from UV radiation, either by virtue of the material of the surface itself, or the incorporation of a UV-absorbing additive. It will be understood, however, that while the improved surface finish can enable the use of composite parts that need not be painted, in some embodiments paint or other surface finishes may nevertheless be applied to the surface.

In some aspects, a composite structure comprises a structural layer comprising reinforcing fibres, such as glass or carbon fibres, and a thermoplastic body polymer. The structure further comprises a surface layer providing a surface finish to the composite structure, the surface layer comprising a thermoplastic surface polymer substantially free from reinforcing fibres. By providing a surface layer without the reinforcing fibres, the reinforcing fibres are shielded from the surface and print-through is consequently reduced, resulting in an improved surface finish.

The term “composite structure” as used in this disclosure encompasses both a precursor structure (wherein the layers are not fused) for making a composite part, and a fused structure, the latter being a composite part. The reinforcing fibres and thermoplastic body polymer may form a plurality of alternating first fibre layers and thermoplastic body polymer layers.

The reinforcing fibres may form a mesh, wherein the thermoplastic body polymer encompasses the mesh of reinforcing fibres. A mesh may be woven or non-woven fabric, or layers of such a fabric; the structural layer may be formed of two or more sub-layers, for example sublayers formed from a mesh of reinforcing fibres. The structural layer may be formed from one or more layers of a mesh or fabric of a yarn of the reinforcing fibres combined with fibres of the thermoplastic body polymer. The mesh or fabric may be woven or non-woven.

In some embodiments, the structure may further comprise a veil layer comprising veil fibres between the structural layer and the surface layer, wherein the veil layer is configured to reduce print-through of the reinforcing fibres into the surface layer, optionally the veil layer may be incorporated into the structural layer. The veil fibres may form a mesh or fabric. The veil fibres may be glass fibres, carbon fibres or any other fibres not adversely affected by heat during processing of the composite, and the fibres may be formed into a yarn. Veil fibres may be provided in the form of a glass or polyester tissue, for example. In any of these embodiments including veil fibres, the diameter of the veil fibres may be between 5 and 15 μm and/or wherein the diameter of the reinforcing fibres may be between 15 and 20 μm. The diameter of the veil fibres may be less than 75%, less than 50%, less than 25% or less than 10% of the diameter of the reinforcing fibres.

In some embodiments, the surface layer, when consolidated, is substantially free of fibres. That is there are no reinforcing or other fibres in the surface layer, although the unconsolidated surface layer may comprise polymer fibres. In some embodiments, the surface layer may be formed from one or more layers of a fabric of thermoplastic polymer yarn, for example a woven or knitted fabric. A woven or knitted fabric is advantageous in that it provides good drape, facilitating the arrangement of the unconsolidated structure in a mould. In one particular example, the surface layer may be woven or knitted from a PET yarn. The surface layer may comprise a coloured layer sandwiched between the structural layer and a clear protective layer.

When consolidated, the surface layer may have a thickness greater than 0.1 mm, 0.2 mm, 0.3 mm, 0.4 mm. 0.5 mm or 0.6 mm. To achieve this thickness, the unconsolidated structure will have an even greater thickness, for example 2-3 mm, due to the empty spaces between the loops of yarn in the woven or knitted fabric. However, as the skilled person will be aware, a given consolidated thickness can be predicted for a given fabric based on the fabrics specific weight, its thickness and the density of the consolidated polymer and so an appropriate number of fabric can be chosen for the unconsolidated structure to achieve a desired consolidated thickness.

In all disclosed aspects and embodiments, the surface layer may comprise one or more of a pigment, a dye, a flame retardant and a UV-absorbing additive and may optionally be painted with a suitable paint to further enhance or alter the finish. The thermoplastic body polymer and/or thermoplastic surface polymer may be a polypropylene-based thermoplastic polymer or a polyester-based thermoplastic polymer and thermoplastic body polymer and the thermoplastic surface polymer may be the same or a different polymer.

In some embodiments, the layers may be fused together to form a composite part, for example a vehicle part or body panel.

A method of manufacturing a part comprising a composite structure comprises arranging a composite structure, for example as described above, in a mould; raising the temperature of the composite structure above a reaction threshold temperature to fuse the composite structure; cooling the composite structure to below the reaction threshold temperature to form the part; and removing the part from the mould. The method may further comprise applying a pressure differential, for example positive pressure applied from outside the mould, across the composite structure while the temperature of the composite structure is above the reaction threshold temperature.

The reaction threshold temperature may be a temperature threshold at which a physical reaction of the thermoplastic body polymer occurs. Examples of a physical reaction include sintering, melting or partial melting the thermoplastic body polymer. A physical reaction may also comprise consolidating the thermoplastic body polymer and reinforcing fibres, for example heating them such that the thermoplastic body polymer becomes fluid enough to flow around the structural fibres. The reaction threshold temperature may be but is not limited to the melting point of the thermoplastic body polymer or the glass transition temperature of the thermoplastic body polymer. During manufacture of the composite structure, the layers may be assembled and cut before being placed in the mould. Alternatively, the layers can be placed in the mould individually to arrange the composite structure in the mould.

In some embodiments, arranging the composite structure in the mould may comprise arranging one or more structural layers and one or more surface layers in the mould, wherein each structural layer comprises a woven fabric woven from a yarn of commingled or otherwise combined reinforcing fibres and thermoplastic polymer fibres and each surface layer comprises a woven or knitted fabric woven or knitted from a thermoplastic polymer yarn. A corresponding composite structure comprises, pre-consolidation, one or more such structural layers and one or more such surface layers.

### Detailed Description of EP 19205196.9

With reference to FIG. B1, in first embodiments, a composite structure B102 comprises a structural layer B104 and a surface layer B106. The term “composite structure” as used herein may refer to both a precursor composite structure, wherein the individual layers are not fused together, and a fused structure, wherein the individual layers have been fused together to form a part, for example as a result of the fusing process described below.

The structural layer B104 comprises reinforcing fibres B108 and a thermoplastic body polymer B110. The structural layer B104 provides the composite structure B102 with the majority of its structural strength once fused by providing a matrix of the body polymer B110 embedded with reinforcing fibres B108. The surface layer B106 provides the composite structure B102 with a surface finish, and comprises a thermoplastic surface polymer B112 that does not comprise (or is at least substantially free from) reinforcing fibres.

Since, in the first embodiments, the surface layer B104 does not comprise any fibres or other reinforcing component, there is nothing within the surface layer B106 itself to cause print-through after fusing of the layers. Moreover, the surface layer B106 acts as a buffer that blocks and obscures print-through from the structural layer B104 beneath.

The reinforcing fibres B108 may be made from many different materials known to the person skilled in the art, such as glass fibre and carbon fibre. The reinforcing fibres B108 may be formed into a yarn, which may be formed into a fabric, mesh or weave. Alternatively, the reinforcing fibres B108 may comprise loose fibres, may be formed into a non-woven, for example a felt, or may take any another other suitable form.

The body polymer B110 may be any thermoplastic polymer, however preferred thermoplastic polymers include polypropylene and polyester such as polyethylene terephthalate (PET), with polypropylene being particularly preferred.

The structural layer may be made from fibres or filaments of the thermoplastic body polymer B110. These fibres can be commingled or otherwise combined with the reinforcing fibres B108 to form a combined yarn, which can be woven into a fabric or mesh.

In a particularly advantageous embodiment, the structural layer B104 may be made from a woven fabric, specifically a combined glass and thermoplastic weave, which comprises glass fibres commingled or otherwise combined with polypropylene filaments that form a combined yarn, with the combined yarn woven into a fabric. More generally, the structural layer B104 may be made from a weave of commingled or otherwise combined fibres of the body polymer B110 and reinforcing fibres B108.

The terms “yarn” and thread are used in a broad sense to cover any yarn or thread of a suitable form factor to be woven, knitted or otherwise constructed into a fabric. In the same sense, the term “fibre” is understood to cover a wide range filaments and cross-sectional form factors of the fibre and is understood to cover tape, and in particular spread tow tape, in relation to either or both of reinforcing and thermoplastic polymer fibres. The yarn may be a combined yarn formed by combining, for example commingling or parallel weaving, different fibres, for example fibres of thermoplastic polymer and reinforcing fibres.

The structural layer B104 may be formed itself from several sublayers, for example several layers of a weave or fabric as described above; other pre-cursor fabrics or weaves; or alternating layers of the thermoplastic body polymer B110 and reinforcing fibres B108, for example alternating layers of a sheet of the thermoplastic body polymer B110 and of a layer of a fabric or weave of reinforcing fibre B108. It will be appreciated that many combinations of such sub layers and alternative arrangements of sublayers forming the structural layer B104 are possible, without departing from the present disclosure. In some embodiments, the reinforcing fibres B108 have a diameter in the range of 15-20 μm.

The surface layer B106 comprises a thermoplastic surface polymer B112, which may be any thermoplastic polymer, including the same material as the thermoplastic body polymer B110 of the structural layer B104, that is the thermoplastic body polymer B110 and thermoplastic surface polymer B112 may be the same. In some embodiments, the surface and body polymers are not the same. A variety of thermoplastic polymers may be used for the surface layer B106, for example polypropylene or polyester, such as polyethylene terephthalate. In some embodiments, the surface layer may have a thickness in a range of 100 to 300 μm, or even more.

In some specific embodiments now described with reference to FIG. B2, the composite structure B102, in its unconsolidated form, has a structural layer B104 comprising one or more woven fabric layers B202 as described above and a surface layer B106 comprising one or more layers B204,B206 of a woven or knitted polymer fabric, woven or knitted from a yarn of polymer fibres, for example PET fibres. The woven or knitted fabric and the number of layers of woven or knitted fabric may be selected based on their thickness, specific weight and polymer density to give a desired consolidated thickness. In one specific example three layers of a PET fibre woven or knitted fabric are used to provide a surface layer thickness of about 0.6 mm in the consolidated structure. A thick surface layer B106 is advantageous in that it better hides the underlying surface structure of the structural layer B104 and therefore achieves a better surface finish as compared to a thin layer that only partially hides the underlying structure. In one specific example, the surface layer B106 comprises a coloured layer B204 between a clear protective layer B206 and the one or more fabric layers of the structural layer B104. The protective layer B206 protects the coloured layer B204 from physical damage to reduce the risk of visible scratches when the part is used. In some embodiment the surface layer B106 comprises coloured and protective layers B204, B206 constructed differently, for example from non-woven fabrics of blown films rather than woven or knitted fabrics.

In some embodiments, the surface layer B106 may comprise one or more of a pigment, a dye, a flame retardant and a UV-absorbing additive in order to bestow desirable properties on the surface layer B106 such as a particular surface colour or UV-resistance. Accordingly, it may not be necessary to paint, coat or wrap the surface layer B106 in order to provide a desirable surface finish.

To manufacture a part comprising the composite structure B102, the layers of the composite structure B104, B106 are first assembled. For example, a surface layer of polyester or PET, fabric or otherwise as described above, may be placed on a fabric of commingled or otherwise combined polypropylene fibres and glass fibres. The layers may then be cut to a desired shape suitable for forming the fused three-dimensional composite structure. Alternatively, the part may first be moulded from the composite structure, with excess trimmed off afterwards.

The temperature of the assembled layers B104, B106 is then raised above a reaction threshold temperature to soften the layers B104, B106. The thermoplastic body polymer and/or thermoplastic surface polymer B110/B112 is/are consolidated, melted (at least partially) or sintered at the reaction threshold temperature, such that the polymer fibres and layers fuse together.

The reaction threshold temperature may be equal to or above the highest of the glass transition/melting temperature of the thermoplastic body polymer B110 and the glass transition/melting temperature of the thermoplastic surface polymer B112, although it may also be lower, so long as the thermoplastic polymers are softened, for example such that the thermoplastic body polymer B110 bonds together. The reaction threshold temperature is typically between 180-220° C., depending of course on the nature of the thermoplastic polymers present. For example, this temperature range is suitable for polypropylene.

The softened or molten layers are then pressed or urged into contact with a mould, for example by applying a pressure differential across the layers, and subsequently cooled to below the reaction threshold temperature, at which point the structural layer B104 and surface layer B106 become fixed in the shape of the mould. The layers may be arranged such that it is the side of the surface layer B106 that is nearest the mould. This process is referred to as fusing of the composite structure B102. It will be appreciated that in some embodiments the steps of softening or melting the layers and moulding of the softened or molten layers may proceed in parallel, that is the initially cool layers may be urged into contact with the mould and heated at the same or at a subsequent time while continuing to urge the composite structure B102 into contact with the mould. The pressure differential may be applied by negative pressure, evacuating air from between the mould and the layers, or by positive pressure to the layers from outside the mould, or both.

A texture tool can be placed in or incorporated into the mould. When softened or melted, the surface material conforms to the surface of the tool—whether gloss, matte or textured—thus reproducing its finish on the surface of the final part. Thus, parts or panels made from the composite structure B102 may be more aesthetically appealing and/or ergonomic, for example, the surface may hide wear-and-tear and/or have improved grip or reduced squeak.

The method may further comprise applying a pressure differential across the composite structure B102, for example as described above, prior to raising the temperature of the composite structure B102 above the reaction threshold temperature. This prevents or reduces the risk of air from being trapped within the layers, which can further improve the surface finish.

With reference to FIG. B3, in second embodiments that reduce print-through of a structural layer B104, a composite structure B102 comprises a structural layer B104, a surface layer B106 and a veil layer B114 between the structural layer B104 and surface layer B106. FIG. B2 illustrates the composite structure B102 of the second embodiment.

In the second embodiments, the structural layer B104 and surface layer B106 are the same as in the first embodiments, however, a veil layer B114 is located between the structural layer B104 and surface layer B106. The veil layer B114 comprises veil fibres B116, such as glass fibres, carbon fibres or any other fibres not adversely affected by heat during processing of the composite, which may be formed into a yarn, which may in turn be formed into a mesh or weave. Alternatively, the veil fibres B116 may comprise loose fibres, may be formed into a felt, or may take another other suitable form.

Importantly, the diameter of the veil fibres B116 is less than the diameter of the reinforcing fibres B108. For example, the diameter of the reinforcing fibres B108 may be between 15-20 μm, and the diameter of the veil fibres B116 may be 5-15 μm. The veil layer is typically very thin, for example, having a single or a few layers of veil fibres B116. Here and in other parts of the disclosure, the “diameter” is the diameter of the fibres themselves, or the diameter of the thread or yarn formed from the individual fibres, whichever is larger.

When the structural layer B104, the surface layer B106 and the veil layer B114 of the second embodiment are fused into a composite structure B102, the veil layer B114 acts as a buffer that blocks print-through from the structural layer B104. Since the diameter of the veil fibres B116 is less than the diameter of the reinforcing fibres B108, the surface layer may smoothly cover the surface variations due to the thinner veil fibres to eliminate print-through. Even if the veil reinforcing fibres B116 do print-through into the surface layer B106, the print-through is much less pronounced, resulting in a further improved surface finish. The “diameter” of the reinforcing fibres and veil fibres may refer to the average or median diameter of the reinforcing fibres or veil fibres.

The veil layer B114 may be provided separately to the structural layer B104 or be integrated with it. That is, the veil layer may be incorporated into the structural layer B104, for example it may be adhered to the structural layer B104, stitched or woven into a side of the structural layer B104, or laminated, stitch-bonded, needle-punched with the structural layer B104, and so on. For example, glass veil fibres B116 may be incorporated into a structural layer B104 comprising a weave of polypropylene fibres B110 and glass reinforcing fibres B108.

The embodiments described above can, of course, comprise further layers, such as further thermoplastic polymer comprising layers, fibre layers, veil layers, or layers of any other material, and should not be understood as being limited to comprising only the layers described above.

As explained above, possible uses for the composite structures B102 include use as vehicle parts or body panels. As would be understood by the person skilled in the art, when the composite structure B102 is fused, the structure can be shaped as required by use of an appropriate mould, for example as described in European patent application EP19205144.9 entitled “MANUFACTURE OF COMPOSITE PART, incorporated by reference.

It will be appreciated that the above description is made by way of example and not limitation of the scope of the appended clauses, including any equivalents as included within the scope of the clauses. Various modifications are possible and will be readily apparent to the skilled person in the art. Likewise, features of the described embodiments can be combined with any appropriate aspect described above and optional features of any one aspect can be combined with any other appropriate aspect. While the described composite structure, method of manufacture and vehicle parts and body panels are particularly advantageous in the context of electric vehicles as explained above, it will be understood that described embodiments are not limited to this application but rather are applicable to any vehicles, be that other road vehicles, for example being driven by internal combustion engines, naval vehicles such as boats, ships and other vessels and airborne vehicles such as planes, helicopters and the like. The disclosure is further equally applicable to stationary structures, such as buildings, requiring low-cost, lightweight and high-strength panels and parts.

### Clauses Corresponding to the Claims of EP 19205196.9

B1. A composite structure comprising:
a structural layer comprising reinforcing fibres and a thermoplastic body polymer; and
a surface layer providing a surface finish to the composite structure, the surface layer comprising a thermoplastic surface polymer substantially free from reinforcing fibres.

B2. The composite structure of clause B1 or B2, wherein the structural layer is formed from one or more layers of a mesh of a yarn of the reinforcing fibres combined with fibres of the thermoplastic body polymer.

B3. The composite structure of any preceding clause, wherein the surface layer, when consolidated, is substantially free of fibres.

B4. The composite structure of clause B3, wherein the surface layer, when consolidated, has a thickness greater than 0.1 mm, 0.2 mm, 0.3 mm, 0.4 mm. 0.5 mm or 0.6 mm.

B5. The composite structure of any preceding clause, wherein the surface layer is formed from one or more layers of a fabric of thermoplastic polymer yarn.

B6. The composite structure of clause B5, wherein the fabric is a woven or knitted fabric.

B7. The composite structure of clause B6, wherein the fabric is woven or knitted from a PET yarn.

B8. The composite structure of any preceding clause, further comprising a veil layer comprising veil fibres between the structural layer and the surface layer, wherein the veil layer is configured to reduce print-through of the reinforcing fibres into the surface layer, optionally wherein the veil layer is incorporated into the structural layer.

B9. The composite structure of any preceding clause, wherein the surface layer comprises a coloured layer between a clear protective layer and the structural layer.

B10. The composite structure of any preceding clause, wherein the layers are fused together to form a composite part.

B11. A vehicle part or body panel formed from the composite structure of any preceding clause.

B12. A method of manufacturing a part comprising a composite structure, the method comprising:
arranging the composite structure of any of clauses B1 to B11 in a mould;
raising the temperature of the composite structure above a reaction threshold temperature to fuse the composite structure;
cooling the composite structure to below the reaction threshold temperature to form the part; and
removing the part from the mould.

B13. The method of clause B12, wherein arranging the composite structure in the mould comprises arranging one or more structural layers and one or more surface layers in the mould, wherein each structural layer comprises a woven fabric woven from a yarn of combined reinforcing fibres and thermoplastic polymer fibres and each surface layer comprises a woven or knitted fabric constructed from a thermoplastic polymer yarn.

B14. The method of clause B12 or B13, wherein the surface layer is facing the mould.

B15. The method of clause B12, B13 or B14, wherein the method further comprises applying a pressure differential across the composite structure while the temperature of the composite structure is above the reaction threshold temperature.

### Section C: Conductive Composite Parts

### EP 19205146.4 (Arrival Ref: #0128-EP)

This section specifies the disclosure of EP 19205146.4, for which we make consistent use of figure numbers and reference numerals.

The present disclosure relates to a method for manufacturing conductive composite parts using a composite layer, the composite layer and the resulting conductive composite parts. Disclosed is a method of manufacturing a conductive composite part (composite structure). First, a composite layer (structural layer) comprising a thermoplastic polymer and structural fibres is provided. Conductive particles are applied to a surface of the composite layer which is then heated above a consolidation temperature, before being cooled to below the consolidation temperature to form the conductive composite part. The disclosed method employs a fundamentally new approach for providing conductivity in plastic composite materials that avoids the difficulty of providing a polymer with bulk conductivity. The thermoplastic polymer may be provided in the form of a fabric comprising a weave of thermoplastic polymer fibres. Also disclosed is a conductive composite structure comprising a composite layer with structural fibres in a matrix of thermoplastic polymer, wherein conductive particles are disposed within the composite layer and the composite layer comprises regions of thermoplastic polymer substantially free of conductive particles. The part may be formed with multiple composite layers, for example including more than one conductive layer, one or more non-conductive layers providing additional structural strength or a combination of conductive and non-conductive layers.

A composite part is a part that is made from a composite material, which is a material made from two or more constituent materials with different physical or chemical properties that, when combined, produce a material with characteristics different from the individual components. The individual components remain separate and distinct within the finished part, differentiating composites from mixtures. The new material may be preferred for many reasons, for example the composite material may offer a mechanical or cost advantage when compared to mono-materials. Naturally, these benefits are also exhibited by a composite part made from a composite material.

Thermoplastic composites are composites comprising a heat-processable thermoplastic polymer or a thermoplastic polymer polymerised in situ. Composite parts formed from thermoplastic composite materials may be preferred to thermoset composites since they tend to be tougher and recyclable; and certain types exhibit excellent resistance to chemicals and weathering (with increased molecular weight and crystallinity, thermoplastics become stiffer, stronger and more resistant to heat and chemicals). Thermoplastic composite materials are available in many forms, for example, as fabrics made from structural fibres, such as glass fibres, and thermoplastic polymer fibres, which are combined together, for example commingled, and then woven together into a fabric.

Conductive composite parts have valuable anti-static and electromagnetic shielding properties, while monitoring the conductivity of a conductive composite part provides a way of detecting strain or damage to the part. Existing solutions for imparting plastic composites with conductivity comprise the preparation of plastics with a homogeneous dispersion of conductive particles, such as carbon black or carbon nanotubes, in the bulk of the plastic. As such, costly functionalisation of the surface of the particles and complex processing are generally required. In particular, it is well established that carbon nanotubes offer a great deal of theoretical benefits, such as a high strength-to-weight ratio and high conductivity. However, they are expensive and difficult to incorporate into the bulk of a plastic in practice.

Thus, new ways of introducing conductivity into polymers to bridge the gap between commodity and performance materials, without the cost implication, are needed.

Aspects of the disclosure are set out in the independent clauses and optional features are set out in the clauses dependent thereon.

Disclosed is a method of manufacturing a conductive composite part. First, a composite layer comprising a thermoplastic polymer and structural fibres is provided. Conductive particles are applied to a surface of the composite layer which is then heated above a consolidation temperature, before being cooled to below the consolidation temperature to form the conductive composite part. Thus, the disclosed method employs a fundamentally new approach for providing conductivity in plastic composite materials that avoids the difficulty of providing a polymer with bulk conductivity. The result may comprise paths of conductive particles within a thermoplastic polymer that has no bulk conductivity itself. That is to say that paths of conductive particles may be separated by bulk thermoplastic polymer substantially free of conductive particles.

The thermoplastic polymer may be provided in the form of a fabric comprising a weave of thermoplastic polymer fibres. A fabric can be understood to be a weave or mesh of fibres and these terms are used interchangeably. The fabric may comprise a weave of combined, for example commingled, fibres, the combined fibres forming threads or yarn comprising thermoplastic polymer and structural fibres combined together. That is, the fabric may be woven from threads of structural and polymer fibres that are already combined together.

Alternatively, the fibres may be combined as they are woven, for example by parallel weaving the separate fibres into the same fabric at the same time. As such, the conductive particles may be disposed between thermoplastic polymer fibres of the composite layer and result in paths of conductive particles in the consolidated polymer material after the heating and cooling steps. Suitable materials for the thermoplastic polymer include polypropylene or a polyester such as polyethylene terephthalate. The structural fibres may be glass fibres, carbon fibres or other types of reinforcing fibres. In the case of carbon or metallic fibres, this may further increase the conductivity of the composite.

The terms “yarn” and thread are used in a broad sense to cover any yarn or thread of a suitable form factor to be woven, knitted or otherwise constructed into a fabric. In the same sense, the term “fibre” is understood to cover a wide range filaments and cross-sectional form factors of the fibre and is understood to cover tape fibres, and in particular spread tow tape fibres, in relation to either or both of reinforcing and thermoplastic polymer fibres.

The composite layer may have a porous or open structure prior to consolidation. Such a material may be formed by weaving as described above or in other ways, for example perforating a sheet of bulk polymer. The composite layer may instead be non-porous, for example combining a sheet such as a blown film of polymer with structural fibres and the conductive particles may be applied to the sheet.

The conductive particles may be applied to the surface of the composite layer by spraying a suspension of the conductive particles onto the composite layer. Alternatively, the composite layer may be imbibed with a suspension of the conductive particles, for example by bathing the composite layer in the suspension of the conductive particles. The conductive particles may be applied in the form of conductive paint. The conductive particles may be suspended in, for example, cellulose acetate or epoxy. The conductive particles may alternatively be applied in dry form, for example as a powder coating, and may be held in place, for example, by electrostatic forces.

The suspension of the conductive particles comprises a liquid, paste or solvent in which the conductive particles are suspended, and this may be removed as part of the method, for example by heating and/or applying a vacuum to the composite layer after the conductive particles have been applied. The liquid or solvent may be compatible with the polymer of the composite layer and thus may not be removed but rather remain and become part of the formed part.

The shape of the final conductive composite part may depend in part on the shape of the composite layer. Accordingly, the method may further comprise cutting the composite layer into a shape suitable for forming a target shape of the composite part.

The conductive particles may be carbon nanotubes, carbon black, graphite powder, metal powder, conductive nanomaterials such as metallic nanoparticles, carbon or silicon nanotubes, and 2D nanomaterials such as graphene flakes. The conductive particles can be substantially rotund, elongate, solid, hollow or tube shaped. The weight of the conductive particles relative to the weight of the composite layer is less than 20%, preferably less than 10%, more preferably less than 5% and most preferably less than 1%.

In accordance with the above, a conductive composite structure comprises a composite layer with structural fibres in a matrix of thermoplastic polymer, wherein conductive particles are disposed within the composite layer and the composite layer comprises regions of thermoplastic polymer substantially free of conductive particles.

The composite layer may comprise a consolidated mesh of thermoplastic polymer fibres and conductive particles embedded within the mesh between the consolidated thermoplastic polymer fibres. The consolidated mesh may have been formed from a mesh of combined fibres, the combined fibres comprising thermoplastic polymer fibres combined together with structural fibres. The fibres may have been combined, as described above. The conductive particles may form paths within the composite layer, the paths being substantially free of the thermoplastic polymer of the composite.

A part may be formed using the method above with multiple composite layers, for example including more than one conductive layer, one or more non-conductive layers providing additional structural strength or a combination of conductive and non-conductive layers. In embodiments with more than one conductive layer, the conductive layers may have mutually different properties, for example conductivity, to serve different functions. The conductive layers may of course have the same properties or conductivity. In either case, separate electrical connections can be made to respective conductive layers, or one or more conductive layers may be provided with an electrical connection and one or more may not be provided with an electrical connection, to server different respective functions like anti-static, resistive heating, strain sensing or power conveying functions, for example.

There are many uses and applications of the conductive composite parts, for example as panels or parts, which may be used as an interior vehicle part or exterior body panel, although the disclosure is in no way limited to this. A panel made from the conductive composite layer may have a sheet resistance of less than 1 MΩ/sq, preferably less than 1 kΩ/sq and more preferably less than 1 Ω/sq.

### Detailed Description of EP 19205146.4

The following method provides a simple yet effective way of incorporating conductive particles into a composite part, increasing its conductivity. With reference to the flow diagram of FIG. C1 and the conductive composite part C200 of FIG. C2 and composite part C300 of FIG. C3, a method of manufacturing a conductive composite part comprises providing C102 a composite layer comprising structural fibres. In some embodiments, the composite layer is provided in the form of a fabric comprising interwoven polypropylene fibres and glass fibres. More generally, the composite layer may be made from any thermoplastic polymer, where preferred thermoplastic polymers include polypropylene and polyester such as polyethylene terephthalate.

The glass fibres within the composite layer are reinforcing fibres that increase the strength of the conductive composite part C200. Thus, these reinforcing fibres may instead be made of many different materials known to the person skilled in the art, such carbon fibre. The reinforcing fibres may be formed into a yarn, which may be formed into a fabric, mesh or weave. The composite layer may be made from fibres or filaments of the thermoplastic polymer. These thermoplastic fibres can be commingled with the reinforcing fibres to form a commingled yarn, which can be woven into a fabric or mesh. Alternatively, the reinforcing fibres may be otherwise combined with the reinforcing fibres for example by parallel-weaving filaments or yarn made from the fibres together into the same fabric, or as a mixture of loose fibres, for example in the form of a felt, or in any other suitable form.

Instead of being a fabric, the composite layer and structural fibres may be formed from several sublayers, for example several layers of a weave or fabric as described above, commingled or otherwise; other pre-cursor fabrics or weaves; or alternating layers of a thermoplastic polymer fabric and of a layer of a fabric or weave of reinforcing fibre. It will be appreciated that many combinations of such sub layers and alternative arrangements of sublayers forming the composite layer and structural fibres are possible, without departing from the present disclosure.

Conductive particles, for example carbon nanotubes, are applied C104 to a surface of the composite layer. The conductive particles, which impart the conductive composite part C200 or C300 with its conductivity, may be any suitable conductive particles such as carbon black, graphite powder, metal powder, conductive nanomaterials such as metallic nanoparticles, carbon or silicon nanotubes, and 2-dimensional (2D) nanomaterials such as graphene flakes. In general, the conductive particles can be substantially rotund, elongate, solid, hollow or tube shaped.

The carbon nanotubes, or more generally the conductive particles, may be applied C104 in many different ways known to the skilled person. For example, a fabric of combined polypropylene fibres and glass fibres (the composite layer) can be laid out and imbibed with a suspension of conductive particles in a solvent, for example by bathing the composite layer in the suspension of the conductive particles or spraying the suspension of the conductive particles on the composite layer. The particles may be suspended in cellulose acetate or epoxy, for example. The solvent then may be removed, for example, it may be evaporated off and as such may be heated and/or removed under vacuum. Alternatively, it may be compatible with the thermoplastic polymer matrix and so may remain throughout the heating and cooling (consolidation) cycle.

The composite layer may have an open structure, such as that of a fabric, mesh, weave or felt, or more generally anything made from fibres or filaments of a thermoplastic polymer. Thus, the composite layer may be formed by weaving or in other ways, for example perforating a sheet of bulk polymer. When the conductive particles are applied C104, they are deposited onto the surface or throughout the open structure of the composite layer, for example amongst the fibres or filaments. It is thought that after the composite layer is consolidated (as described below), the particles may form continuous paths (wherein the particles are in electrical contact with each other) passing through the composite layer. The conductive particles are not homogeneously mixed within the composite layer. They may form discrete paths that are substantially free of the polymer of the composite layer, the bulk of the composite layer being substantially free of the conductive particles and surrounding the paths.

Since the conductive particles are not homogeneously dispersed throughout the consolidated composite layer where they can become electrically isolated, the percentage weight of conductive particles relative to the composite layer may be reduced while still imparting the composite layer with conductivity. As such, the weight percentage of the conductive particles relative to the composite layer may be less than 20%, preferably less than 10%, more preferably less than 5% and most preferably less than 1%.

Further layers may be provided next to the composite layer upon which the conductive particles have been applied. For example, a second composite layer similar to the composite layer can be provided on or under a first composite layer. The further layers may or may not be provided with conductive particles. Such further layers can be used to tailor the structural properties of the conductive composite part C200 or C300 (if multiple conductive layers are provided). For example, the composite part C300 has two conductive layers. Multiple conductive layers may be provided by applying conductive particles to a surface of a first composite layer, disposing a second composite layer on the first one and applying conductive particles to the second composite layer, prior to consolidating the layers as described above. More than two layers may be provided in a similar fashion, with or without applying conductive particles to each layer in turn. In this way, a stack of two or more layers can be provided.

By providing separate layers of conductive particles, a multitude of conductive elements may be combined, without interfering with one another. For example, a surface layer in the stack may provide anti-static properties and subsequent, interior, layers provide additional functionality, such as routing power, resistive heating or measuring strain.

Next, the layers are consolidated. The temperature of the composite layer, structural fibres, conductive particles and any further layers is raised C106 above a consolidation temperature, at which point the thermoplastic of the composite layer is fluid enough to flow around the structural fibres. If the thermoplastics in the composite layer melt at the consolidation temperature, polymer fibres of the thermoplastics may fuse together once cooled below their melting point, forming a continuous structure. In some embodiments, the fibres may melt only partially and thus fuse at their interfaces only, or only some of the fibres may melt completely while others fuse at their interfaces only.

The consolidation temperature may be equal to or above the glass transition/melting temperature of the thermoplastics in the composite layer, although it may also be lower, so long as the thermoplastics become fluid enough to flow around the structural fibres or fuse otherwise. The consolidation temperature is typically between 180-220° C., depending of course on the nature of the thermoplastic polymers present. For example, this temperature range is suitable for polypropylene.

The layers can be pressed or urged C108 into contact with a mould, under their own weight, by application of positive or negative fluid pressure, mechanical pressing or otherwise, at which point the composite layer (and the structural fibres and conductive particles) takes on the shape of the mould. The layers are then cooled C110 to below the consolidation temperature to form the conductive composite part C200 or C300. It will be appreciated that in some embodiments the steps of softening or melting the layers and moulding of the softened or molten layers may proceed in parallel, that is the initially cool layers may be urged into contact with a mould and heated at the same or at a subsequent time while continuing to urge the composite layer into contact with the mould.

The shape of the final conductive composite part may depend in part on the shape of the composite layer. Accordingly, the method may further comprise cutting the composite layer into a shape suitable for forming a target shape of the composite part in the mould, for example as part of providing the composite layer at step C102. Alternatively, the composite layer may be cut to shape after applying C104 the conductive particles.

In accordance with the above, and with reference to FIG. C2, a (consolidated) conductive composite part C200 comprises one or more polypropylene composite layer C202, glass structural fibres C204 and carbon nanotube conductive particles C206 within or on the composite layer C202. The composite part may, in some embodiments have several of the described conductive composite layers consolidated together, for example two such layers as illustrated for composite part C300 in FIG. C3. Equally conductive composite layers are in some embodiments combined with non-conductive composite layers to enhance the structural properties of the resulting part, for example omitting the conductive particles from one of the layers in FIG. C3 to provide a conductive portion either closer to one or the other surface of the part C300. Numerous combinations of one or more conductive layers with non-conductive layers are equally envisaged, for example, one more conductive layers sandwiched between non-conductive structural layers or at one end of a stack of structural layers. Figures C2 and C3 is an illustration and is not intended to be an accurate representation of the distribution of glass structural fibres C204 and carbon nanotube conductive particles C206 within the composite layer C202.

A panel or sheet may be made from the conductive composite parts disclosed above, for example part C200 or part C300 disclosed above. Accordingly, the consolidated panel or sheet may have a sheet resistance of less than 1 MΩ/sq, preferably less than 1 kΩ/sq and more preferably less than 1 Ω/sq. Such a panel has many applications, such as in a vehicle, wherein strain or structural integrity of the panel can be monitored by measuring the conductivity of the panel, while such panels prevent the build-up of static charge.

It will be appreciated that the above description is made by way of example and not limitation of the scope of the appended clauses, including any equivalents as included within the scope of the clauses. Various modifications are possible and will be readily apparent to the skilled person in the art. Likewise, features of the described embodiments can be combined with any appropriate aspect described above and optional features of any one aspect can be combined with any other appropriate aspect.

### Clauses Corresponding to the Claims of EP 19205146.4

C1. A method of manufacturing a conductive composite part, the method comprising:
providing a composite layer comprising a thermoplastic polymer and structural fibres;
applying conductive particles onto a surface of the composite layer;
heating the composite layer and applied conductive particles above a consolidation temperature of the composite layer; and
cooling the composite layer to below the consolidation temperature to form the conductive composite part.

C2. The method of clause C1, wherein the thermoplastic polymer is provided in the form of a fabric comprising a weave of thermoplastic polymer fibres.

C3. The method of clause C2, wherein the fabric comprises a weave of combined fibres, each combined fibre comprising thermoplastic polymer and structural fibres combined together.

C4. The method of any preceding clause, wherein applying conductive particles to the composite layer comprises applying, for example spraying, a suspension of the conductive particles onto the composite layer.

C5. The method of any preceding clause, wherein applying conductive particles to the composite layer comprises applying conductive paint to the composite layer.

C6. The method of any preceding clause, comprising disposing a further composite layer onto the composite layer and applying conductive particles to the further composite layer before heating the composite layer, further composite layer and applied conductive particles.

C7. A conductive composite part comprising:
a composite layer comprising structural fibres in a matrix of thermoplastic polymer, wherein conductive particles are disposed within the composite layer and the composite layer comprises regions of thermoplastic polymer substantially free of conductive particles.

C8. The conductive composite part of clause C7, wherein the polymer matrix comprises a consolidated mesh of thermoplastic polymer fibres and conductive particles are embedded within the mesh between the consolidated thermoplastic polymer fibres.

C9. The conductive composite part of clause C8, wherein the consolidated mesh was formed from a mesh of combined fibres, the combined fibres comprising thermoplastic polymer fibres combined together with structural fibres.

C10. The conductive composite part of any of clauses C7 to C9, wherein the composite layer is consolidated together with an adjacent composite layer.

C11. The conductive composite part of clause C10, wherein the adjacent composite layer comprises conductive particles.

C12. The conductive composite part of clause C10 or C11, wherein a sheet conductivity of the adjacent composite layer is different from a sheet conductivity of the composite layer.

C13. The method of any of clauses C1 to C6 or the conductive composite part of any of clauses C7 to C12, wherein the conductive particles are carbon nanotubes.

C14. The method of any of clauses C1 to C6 or the conductive composite part of any of clauses C7 to C13, wherein the weight of the conductive particles relative to the weight of the composite layer is less than 20%, preferably less than 10%, more preferably less than 5% and most preferably less than 1%.

C15. A vehicle comprising the conductive composite part of any of clauses C7 to C14.

### Section D: Recycling of Composite Materials

### EP 19205145.6 (Arrival Ref: #0129-EP)

This section specifies the disclosure of EP 19205145.6, for which we make consistent use of figure numbers and reference numerals.

The present disclosure relates to a method for recycling a thermoplastic composite fabric, and the resulting recycled fabric. Disclosed is a method of recycling thermoplastic composite fabric, wherein the thermoplastic composite fabric is a precursor for making a composite structure. The method comprises: providing thermoplastic composite fabric offcuts comprising a weave of thermoplastic polymer fibres and structural fibres, and combining the thermoplastic fabric offcuts to form recycled thermoplastic composite fabric, wherein the recycled thermoplastic composite fabric is a precursor for making a first composite structure. The offcuts may be combined by fluffing up and needle punching. Also disclosed is a corresponding recycled thermoplastic composite fabric and a composite part made using such a fabric, as well as precursor materials and composite parts comprising a non-woven thermoplastic composite core.

A composite structure is a structure that is made from a composite material, which is a material made from two or more constituent materials with significantly different physical or chemical properties that, when combined, produce a material with characteristics different from the individual components. The individual components remain separate and distinct within the finished structure, differentiating composites from mixtures. The new material may be preferred for many reasons, for example the composite material may be stronger, lighter, or less expensive when compared to traditional materials. Naturally, these benefits are also exhibited by a composite structure or part made from a composite material.

Thermoplastic composites are composites comprising a thermoplastic polymer, which can be heat-processed. Composite structures and parts formed from thermoplastic composite materials, such as fabrics made from combined, for example commingled, glass and thermoplastic polymer fibres, may be preferred to thermoset composites since they tend to be less brittle, can have better chemical resistance and can be more easily repaired.

Due to environmental and cost considerations there is an increasing tendency to recycle as much as possible but satisfactory recycling methods are not currently available in the context of composite material processing.

Aspects of the disclosure are set out in the independent clauses and optional features are set out in the clauses dependent thereon.

Disclosed is a method of recycling thermoplastic composite fabric, wherein the thermoplastic composite fabric is a precursor for making a composite structure. The method comprises: providing thermoplastic composite fabric offcuts comprising a weave of thermoplastic polymer fibres and structural fibres, and combining the thermoplastic fabric offcuts to form recycled thermoplastic composite fabric, wherein the recycled thermoplastic composite fabric is a precursor for making a first composite structure. The wording “precursor for making a composite structure” as used herein means the fabric (both recycled and non-recycled) is suitable for being heated and moulded into a composite structure, for example as described below, either with or without further shaping or cutting.

It has been identified that by using thermoplastic composite fabric as a precursor material to manufacture composite structures (as opposed to using pre-consolidated thermoplastic composite sheet material, known as “organo sheet”, for example, or thermoset, resin-based techniques), the precursor material can be efficiently recycled with little loss of mechanical properties.

Generally, when thermoplastic composite fabric is cut to shape before being heated and moulded into a composite structure, thermoplastic composite fabric offcuts are left over. Ordinarily recycling methods for polymer materials involve shredding the materials into pellets and using the pellets as a feedstock for injection moulding. As a feedstock for injection moulding, the offcuts would have a much lower value than the fabric from which they were cut. Instead of being wasted or turned into injection moulding feedstock, in the present method offcuts of the precursor material are combined into recycled thermoplastic composite fabric suitable for moulding into a further composite structure, realising the full value of the offcuts. A “fabric” can be understood to be a weave, mesh or non-woven structure of fibres, such as a felt. Turning to the materials of the thermoplastic composite fabric offcuts (and, therefore, the fabric from which they were cut) the thermoplastic polymer fibres may be made of any thermoplastic polymer such as polypropylene or a polyester such as polyethylene terephthalate. The structural fibres may be made of any structural fibre known to the skilled person, such as glass fibre or carbon fibre, so long as the fibres are not adversely affected by heat during processing of the thermoplastic composite fabric into a composite structure (known as consolidation of the composite). Thus, a thermoplastic composite fabric comprises a weave of thermoplastic polymer fibres and structural fibres.

The fabric of the precursor material may comprise a weave of combined, for example commingled, fibres, the combined fibres forming a yarn or thread comprising thermoplastic polymer and structural fibres combined together. That is, the fabric may be woven from structural fibres and polymer fibres that are already combined together. Alternatively, the fibres may be combined as they are woven, for example by parallel weaving the separate fibres into the same fabric at the same time. In each case, the fabric may be a non-woven fabric, such as a felt, of the combined fibres instead of a woven fabric.

The terms “yarn” and “thread” are used in a broad sense to cover any yarn or thread of a suitable form factor to be woven, knitted or otherwise constructed into a fabric. In the same sense, the term “fibre” is understood to cover a wide range filaments and cross-sectional form factors of the fibre and is understood to cover tape, and in particular spread tow tape, in relation to either or both of reinforcing and thermoplastic polymer fibres. The yarn may be a combined yarn formed by combining, for example commingling or parallel weaving, different fibres, for example fibres of thermoplastic polymer and reinforcing fibres.

Thermoplastic composite fabric offcuts may be sourced from a third party or otherwise prepared independently of the present method. Alternatively, the method may incorporate cutting thermoplastic composite fabric into a main portion for making a second composite structure and an offcut portion, wherein an offcut portion is one of the thermoplastic composite fabric offcuts. The first and second composite structures made from the recycled thermoplastic composite fabric and main portion, respectively, may be the same or different, and may be made in any order. The main portion may be cut from a roll or other supply of thermoplastic composite fabric, and the cutting may result in multiple offcuts. The offcut portion is generally smaller than the main portion and not suitable for making a further thermoplastic composite structure by itself. For example, the offcut may be too small of the wrong shape. It will be understood that the thermoplastic composite fabric offcuts that are recycled together will not necessarily all be cut from the same piece or even the same supply of thermoplastic composite fabric.

Turning to how the thermoplastic composite fabric offcuts are combined, this may comprise needle punching the thermoplastic composite fabric offcuts together and/or stitching the thermoplastic composite fabric offcuts together. In some specific embodiments, combining the thermoplastic composite fabric offcuts comprises at least partially separating the fibres of the offcut fabric, for example fluffing up the fibres and shredding them to within a range of fibre length. The partially separated fibres are then formed into a non-woven fabric such as a felt, for example by needle punching, to form the recycled thermoplastic composite material.

The method may further comprise heating the recycled thermoplastic composite fabric in a mould to form a composite structure, or the recycled thermoplastic may be provided to a third party for their use. The recycled thermoplastic composite fabric may be sandwiched between layers of non-recycled thermoplastic composite material prior to the forming operation to provide a precursor material that is used to form the composite part.

In accordance with the above, also disclosed is a recycled thermoplastic composite fabric formed from thermoplastic composite fabric offcuts as described above, as well as a composite part formed from such a recycled thermoplastic composite fabric. More generally, aspects of the disclosure extend to a precursor material comprising a non-woven thermoplastic composite fabric core (recycled or made from non-recycled fibres) sandwiched between woven thermoplastic composite fabrics and a composite part made from such a precursor material. The fabrics in question may be formed from thermoplastic polymer and structural fibres such as glass or carbon fibres, in some embodiments combined, for example commingled, fibres.

### Detailed Description of EP 19205145.6

FIG. D1 is a flow diagram of a method of recycling thermoplastic composite fabric, as illustrated in FIG. D2. The method comprises providing D102 thermoplastic composite fabric offcuts comprising a weave of thermoplastic polymer fibres and structural fibres. For example, thermoplastic composite fabric D202 is cut into a main portion D204 and (for example) four thermoplastic composite fabric offcuts D206. The main portion D204 may be later processed into a composite structure. The method further comprises combining D104 thermoplastic fabric offcuts D206 to form recycled thermoplastic composite fabric D208, which can later be processed into a further composite structure. The recycled thermoplastic composite fabric D208 comprises a seam D210 where the thermoplastic composite fabric offcuts D206 have been joined together when they were combined, for example by needle punching or stitching. As illustrated in FIG. D2, the offcut portion may be smaller than the main portion and may not be suitable for making the further thermoplastic composite structure, if it needs to be a similar size to the main portion D204.

With reference to FIG. D3 to D5, in some embodiments of combining D104 the offcuts, the offcuts D206 are combined to form a non-woven fabric. In some specific implementations, the off-cuts D206 are fluffed up D302 to form a fluff or tangle of fibres, illustrated in FIG. D4. Fluffing up may involve partially separating the fibres from the weave of fibres in the offcuts, for example by combing or other mechanical separation techniques. The fibres may also be shredded to produce fibres substantially within a range of fibre length, for example with the majority of fibres, say 80%, within the range. The range may, for example, be about 1 cm to 5 cm, which has been found to provide a good compromise between the structural properties of the resulting material and the uniformity of the fluffed up fibres. The mechanical separation and shredding may occur in a single operation, for example a shredding operation or may involve separate steps.

The resulting fluff is then processed to form D304 a non-woven fabric, such as a felt. The non-woven fabric may be formed, for example by needle punching. The process thus produces a non-woven fabric that can be used as a recycled thermoplastic polymer precursor material. An example machine for producing the non-woven fabric by needle punching and the resulting non-woven fabric are illustrated in FIG. D5. Advantageously, by avoiding seams between off-cut portions, this non-woven fabric has uniform structural properties as compared to the recycled fabric described above with reference to FIG. D2, while, in some embodiments, enabling a significant proportion of the achievable structural strength (as compared to parts formed from the original fabric) to be retained, due to the relatively high length of fibres that can be retained in the non-woven fabric.

A specific application of the recycled thermoplastic composite fabric, be it woven or non-woven, is to use the recycled thermoplastic composite fabric as a core layer D602 in between (non-recycled) thermoplastic composite precursor material layers D604, as illustrated in Figure D6. The use of the non-woven recycled material is particularly advantageous as the bulk and density of the core layer can be adjusted by suitable choice of the parameters of the needle punching process.

The method may be used to recycle any thermoplastic composite fabric D202 comprising thermoplastic polymer fibres and structural fibres. Examples of thermoplastic polymer fibres that may be used are polypropylene, polyester or polyethylene terephthalate. Examples of structural fibres that may be used are glass fibres or carbon fibres. The method is not limited to these examples and any other suitable thermoplastic polymer fibres or structural fibres known to the skilled person may be used.

In some embodiments, the polypropylene fibres and glass fibres may be combined, for example commingled, such that the fabric may comprise a weave of combined fibres, the combined fibres forming a yarn comprising polypropylene polymer and glass fibres combined together. That is, the fabric may be woven from yarn comprising glass and polypropylene fibres that are already combined together. Alternatively, the fibres may be combined as they are woven, for example by parallel weaving separate polypropylene and glass fibres into the same fabric at the same time. More generally, any thermoplastic polymer fibres and structural fibres of the thermoplastic composite fabric may be combined.

The thermoplastic fabric offcuts are combined D104 to form recycled thermoplastic composite fabric D208, wherein the recycled thermoplastic composite fabric D208 is a precursor for making a further composite structure.

It will be appreciated that providing D102 the thermoplastic composite fabric offcuts D206 may comprise cutting the thermoplastic composite fabric D202 into a main portion D204 for making a composite structure and an offcut portion, as described above, or the offcuts may be provided by a third party.

The method may further comprise heating the recycled thermoplastic composite fabric D208 in a mould to form a composite structure (i.e. the recycled thermoplastic composite fabric D208 may be consolidated). Specifically, the temperature of the recycled thermoplastic composite fabric D208 is raised above a consolidation temperature, at which point the polypropylene is fluid enough to wet-out (flow around) the glass fibres. If the polypropylene melts at the consolidation temperature, polypropylene fibres may fuse together once cooled below their melting point, forming a continuous structure. The consolidation temperature may be equal to or above the glass transition/melting temperature of the polypropylene, although it may also be lower, so long as the polypropylene becomes fluid enough to flow around the glass fibres. The consolidation temperature is typically between 180-220° C. for polypropylene. As would be understood, the consolidation temperature may be different for different thermoplastics.

The recycled thermoplastic composite fabric D208 is then pressed or otherwise urged into contact with a mould, under its own weight, fluid pressure, mechanical pressure or otherwise, at which point the recycled thermoplastic composite fabric D208 takes on the shape of the mould. The recycled thermoplastic composite fabric D208 is then cooled to below the consolidation temperature to form a composite structure. This composite structure may be the same or may be different from the one made from the main portion D204.

It will be appreciated that the above description is made by way of example and not limitation of the scope of the appended clauses, including any equivalents as included within the scope of the clauses. Various modifications are possible and will be readily apparent to the skilled person in the art. Likewise, features of the described embodiments can be combined with any appropriate aspect described above and optional features of any one aspect can be combined with any other appropriate aspect.

### Clauses Corresponding to the Claims of EP 19205145.6

D1. A method of recycling thermoplastic composite fabric, wherein the thermoplastic composite fabric is a precursor for making a first composite structure, the method comprising:
providing thermoplastic composite fabric offcuts comprising a weave of thermoplastic polymer fibres and structural fibres; and
combining the thermoplastic fabric offcuts to form recycled thermoplastic composite fabric, wherein the recycled thermoplastic composite fabric is a precursor for making a second composite structure.

D2. The method of clause D1, wherein providing thermoplastic composite fabric offcuts comprises cutting the thermoplastic composite fabric into a main portion for making the first composite structure and an offcut portion, wherein the offcut portion is one of the thermoplastic composite fabric offcuts.

D3. The method of clause D2, wherein the offcut portion is smaller than the main portion and/or is not suitable for making the further thermoplastic composite structure.

D4. The method of any preceding clause, wherein combining the thermoplastic composite fabric offcuts comprises fluffing up the thermoplastic composite fabric offcuts and combining the fluffed up thermoplastic composite fabric offcuts into a non-woven fabric to form the recycled thermoplastic composite fabric.

D5. The method of clause D4 comprising needle punching the fluffed up thermoplastic composite fabric offcuts to form the non-woven fabric.

D6. The method of clause D4 or D5, wherein fluffing up the thermoplastic composite fabric offcuts comprises at least partially mechanically separating and shredding the thermoplastic composite fabric offcuts.

D7. The method of clause D6, wherein shredding the thermoplastic composite fabric offcuts results in fibres with a length in the range of 1 to 5 cm.

D8. The method of clause D1, D2 or D3, wherein combining the thermoplastic composite fabric offcuts comprises needle punching the thermoplastic composite fabric offcuts together and/or stitching the thermoplastic composite fabric offcuts together.

D9. The method of any preceding clause, the method further comprising heating the recycled thermoplastic composite fabric in a mould to form the first composite structure.

D10. A recycled thermoplastic composite fabric formed from thermoplastic composite fabric offcuts, the thermoplastic composite fabric offcuts each comprising a fabric of thermoplastic polymer fibres and structural fibres.

D11. The recycled thermoplastic composite fabric of clause D10, wherein the recycled thermoplastic composite fabric is a non-woven fabric.

D12. The recycled thermoplastic composite fabric of clause D10, wherein the thermoplastic composite fabric offcuts have been fluffed up and needle punched together to form the recycled thermoplastic composite fabric.

D13. The recycled thermoplastic composite material according to any one of clauses D10 to D12 sandwiched as a core between layers of non-recycled thermoplastic composite material.

D14. The thermoplastic composite fabric of any one of clauses D10 to D13, made using a method according to any one of clauses D1 to D9.

D15. A thermoplastic composite part formed from thermoplastic composite fabric comprising a non-woven thermoplastic composite fabric core sandwiched between woven thermoplastic composite fabrics.

1. A method of manufacturing a part comprising a composite structure, the method comprising:
arranging the composite structure in a mould;
raising the temperature of the composite structure above a reaction threshold temperature to fuse the composite structure;
while the temperature of the composite structure is above the reaction threshold temperature, applying a pressure differential across the composite structure by evacuating air from inside the mould, such that the pressure differential comprises a vacuum pressure;
cooling the composite structure to below the reaction threshold temperature to form the part; and
removing the part from the mould.

2. The method of claim 1, wherein arranging the composite structure in the mould comprises arranging one or more structural layers and one or more surface layers in the mould, wherein each structural layer comprises a woven fabric woven from a yarn of combined reinforcing fibres and thermoplastic polymer fibres and each surface layer comprises a woven or knitted fabric constructed from a thermoplastic polymer yarn.

3. The method of claim 2, wherein the surface layer is facing the mould.

4. (canceled)

5. The method of claim 1, the method comprising:
providing the composite structure on a supporting surface;
providing a mould positioned above the composite structure;
creating the pressure differential across the composite structure to conform the composite structure to the mould;
fusing the composite structure to form the composite part; and
removing the composite part from the mould.

6. The method of claim 1, the method comprising:
applying conductive particles onto one or more structural layer of the composite structure;
heating the one or more structural layer and applied conductive particles above a consolidation temperature of the one or more structural layer; and
cooling the one or more structural layer to below the consolidation temperature to form a conductive composite part.

7. The method of claim 1, the method comprising:
wherein one or more structural layer of the composite structure is formed from recycled thermoplastic composite fabric.

8. A part comprising a composite structure, the composite structure comprising:
a structural layer comprising reinforcing fibres and a thermoplastic body polymer; and
a surface layer providing a surface finish to the composite structure, the surface layer comprising a thermoplastic surface polymer substantially free from reinforcing fibres.

9. The part of claim 8, wherein the structural layer is formed from one or more layers of a mesh of a yarn of the reinforcing fibres combined with fibres of the thermoplastic body polymer.

10. The part of claim 8, wherein the surface layer, when consolidated, is substantially free of fibres.

11. The part of claim 10, wherein the surface layer, when consolidated, has a thickness greater than 0.1 mm, 0.2 mm, 0.3 mm, 0.4 mm 0.5 mm or 0.6 mm.

12. The part of claim 8, wherein the surface layer is formed from one or more layers of a fabric of thermoplastic polymer yarn.

13. The part of claim 12, wherein the fabric is a woven or knitted fabric.

14. (canceled)

15. The part of claim 8, further comprising a veil layer comprising veil fibres between the structural layer and the surface layer, wherein the veil layer is configured to reduce print-through of the reinforcing fibres into the surface layer.

16. The part of claim 15, wherein the veil layer is incorporated into the structural layer.

17. The part of claim 8, wherein the surface layer comprises a coloured layer between a clear protective layer and the structural layer.

18. The part of claim 8, wherein the layers are fused together to form a composite part.

19. The part of claim 8, the part comprising:
a composite layer comprising structural fibres in a matrix of thermoplastic polymer, wherein conductive particles are disposed within the composite layer and the composite layer comprises regions of thermoplastic polymer substantially free of conductive particles.

20. The part of claim 8, the part being a vehicle part or body panel.

21. The part of claim 8, the part being manufactured from a recycled thermoplastic composite fabric formed from thermoplastic composite fabric offcuts, the thermoplastic composite fabric offcuts each comprising a fabric of thermoplastic polymer fibres and structural fibres.

22. The part of claim 21, the wherein the recycled thermoplastic composite fabric comprises a non-woven thermoplastic composite fabric core sandwiched between woven thermoplastic composite fabrics.

23. (canceled)
